(19) United States
(12) Patent Application Publication
(10) Pub. No.: US 2025/0111849 A1
(43) Pub. Date: Apr. 3, 2025

(54) SYSTEM, APPARATUS, AND METHOD OF SUPPORTING COMMUNICATION

(71) Applicant: Kazuhiko KOGAMI, Kanagawa (JP)

(72) Inventor: Kazuhiko KOGAMI, Kanagawa (JP)

(21) Appl. No.: 18/884,109

(22) Filed: Sep. 13, 2024

(30) Foreign Application Priority Data
Sep. 28, 2023 (JP) 2023-168742
Dec. 26, 2023 (JP) 2023-219902

(51) Int. Cl. G10L 15/22; G10L 15/08; G10L 15/30

(52) U.S. Cl. CPC G10L 15/22; G10L 15/08; G10L 15/30; G10L 2015/088

(57) ABSTRACT

A system for supporting communication includes circuitry configured to: acquire a speech uttered by one or more participants participating in the communication; determine, in accordance with an utterance made by the one or more participants, whether the communication is to be supported, from the speech uttered by the one or more participants; and provide information supporting the communication based on a determination that the communication is to be supported.

### CROSS-REFERENCE TO RELATED APPLICATIONS

This patent application is based on and claims priority pursuant to 35 U.S.C. § 119(a) to Japanese Patent Application Nos. 2023-168742, filed on Sep. 28, 2023, and 2023-219902, filed on Dec. 26, 2023, in the Japan Patent Office, the entire disclosure of which is hereby incorporated by reference herein.

### BACKGROUND

### Technical Field

The present disclosure relates to a system, an apparatus, and a method of supporting communication.

### Related Art

The background system transmits and receives content data such as video data and audio data between terminal apparatuses.

### SUMMARY

Example embodiments include a system for supporting communication includes circuitry. The circuitry acquires a speech uttered by one or more participants participating in the communication, determine, in accordance with an utterance made by the one or more participants, whether the communication is to be supported, from the speech uttered by the one or more participants, and provide information supporting the communication based on a determination that the communication is to be supported.

Example embodiments include an apparatus for supporting communication includes circuitry. The circuitry acquires a speech uttered by one or more participants participating in the communication, determines, in accordance with an utterance made by the one or more participants, whether the communication is to be supported, from the speech uttered by the one or more participants, and provides information supporting the communication based on a determination that the communication is to be supported.

Example embodiments include a method for supporting communication includes acquiring a speech uttered by one or more participants participating in the communication; determining, in accordance with an utterance made by the one or more participants, whether the communication is to be supported, from the speech uttered by the one or more participants; and providing information supporting the communication based on a determination that the communication is to be supported.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example system configuration of a communication support system according to a first embodiment of the present disclosure;

FIG. 2 is a diagram illustrating another example system configuration of the communication support system according to the first embodiment of the present disclosure;

FIG. 3 is a diagram illustrating an example hardware configuration of a computer according to one or more embodiments of the present disclosure;

FIG. 4 is a diagram illustrating an example hardware configuration of a terminal apparatus according to one or more one or more embodiments of the present disclosure;

FIG. 5 is a diagram illustrating an example functional configuration of the communication support system according to the first embodiment of the present disclosure;

FIGS. 6A and 6B are illustrations of support databases according to the first embodiment of the present disclosure;

FIG. 7 is a flowchart illustrating an example of a data registration process according to the first embodiment of the present disclosure;

FIG. 8 is a flowchart illustrating an example of a communication support process according to the first embodiment of the present disclosure;

FIG. 9 is an illustration of an example of a display screen of support information according to the first embodiment of the present disclosure;

FIG. 10 is a diagram illustrating a support database according to a modification of the first embodiment of the present disclosure;

FIG. 11 is a flowchart illustrating an example of a data registration process according to the modification of the first embodiment of the present disclosure;

FIG. 12 is an illustration of an example of a data registration screen according to the modification of the first embodiment of the present disclosure;

FIG. 13 is a flowchart illustrating an example of a support database selection process according to the modification of the first embodiment of the present disclosure;

FIG. 14 is an illustration of an example of an application screen according to the modification of the first embodiment of the present disclosure;

FIG. 15 is an illustration of an example of mode management information according to the modification of the first embodiment of the present disclosure;

FIG. 16 is an illustration of another example of the application screen according to the modification of the first embodiment of the present disclosure;

FIG. 17 is a diagram illustrating an example system configuration of an information processing system according to a second embodiment of the present disclosure;

FIG. 18 is a diagram illustrating an example functional configuration of the information processing system according to the second embodiment of the present disclosure;

FIG. 19 is a diagram illustrating an example functional configuration of a data processing unit according to the second embodiment of the present disclosure;

FIG. 20 is a flowchart illustrating an example of a process performed by the terminal apparatus according to the second embodiment of the present disclosure;

FIGS. 21A and 21B are illustrations of an example of operation screens on the terminal apparatus according to the second embodiment of the present disclosure;

FIG. 22 is a flowchart illustrating an example of data processing according to the second embodiment of the present disclosure;

FIG. 23 is a flowchart illustrating an example of an evaluation process according to the second embodiment of the present disclosure;

FIGS. 24A and 24B are illustrations of an example of a fit rate according to the second embodiment of the present disclosure;

FIG. 25 is an illustration of an example of an evaluation message according to the second embodiment of the present disclosure;

FIG. 26 is a flowchart illustrating another example of the evaluation process according to the second embodiment of the present disclosure;

FIG. 27 is an illustration of an example of how an evaluation result is used according to a first modification of the second embodiment of the present disclosure;

FIG. 28 is a flowchart illustrating an example of an analysis report creation process according to the first modification of the second embodiment of the present disclosure;

FIG. 29 is an illustration of an example of a method for extracting a business negotiation to be managed according to the first modification of the second embodiment of the present disclosure;

FIG. 30 is an illustration of an example of an analysis report according to the first modification of the second embodiment of the present disclosure;

FIG. 31 is an illustration of an example of a confirmation screen according to the first modification of the second embodiment of the present disclosure;

FIG. 32 is a flowchart illustrating an example of a conversational speech reproduction process according to the first modification of the second embodiment of the present disclosure;

FIG. 33 is a flowchart illustrating an example of an analysis report creation process according to a second modification of the second embodiment of the present disclosure; and

FIG. 34 is an illustration of an example of an analysis report according to the second modification of the second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### System Configuration

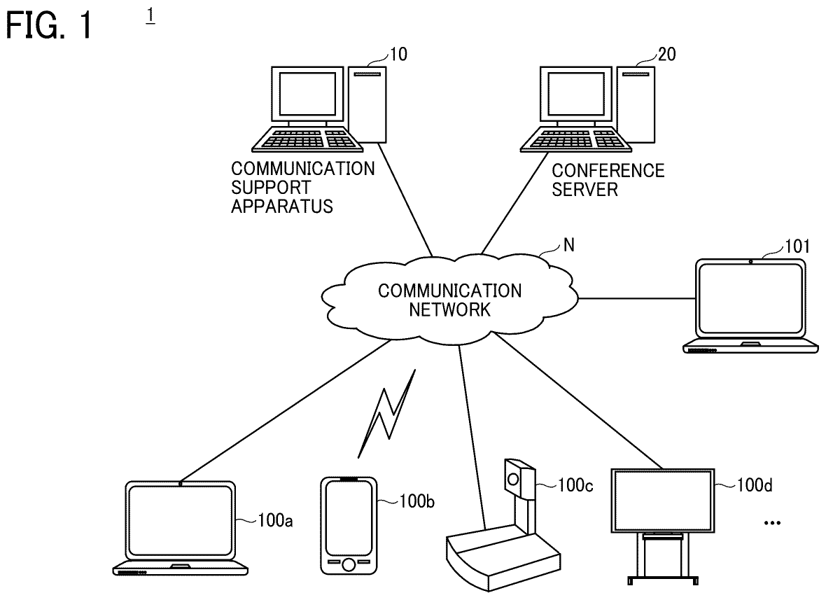

A first embodiment will be described with reference to FIGS. 1 to 16. In the first embodiment, an information processing system 1 is a communication support system. The information processing system 1 includes an information processing apparatus 10. In the first embodiment, the information processing apparatus 10 is a communication support apparatus. In the first embodiment, the information processing system 1 and the information processing apparatus 10 are referred to as a communication support system 1 and a communication support apparatus 10, respectively.

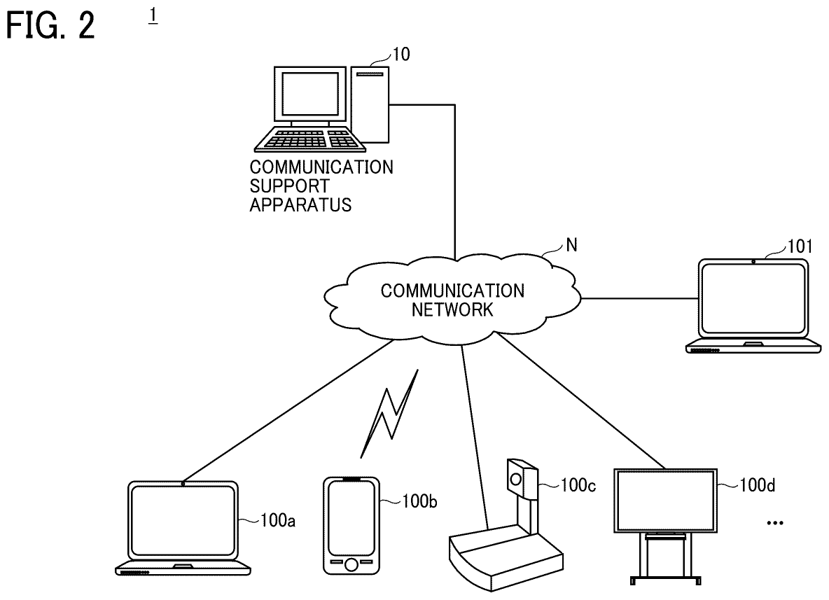

FIGS. 1 and 2 are diagrams illustrating example system configurations of the communication support system 1. As illustrated in FIG. 1, the communication support system 1 includes the communication support apparatus 10, a conference server 20, a plurality of terminal apparatuses 100a, 100b, 100c, 100d, etc., and an information terminal 101, which are connected to a communication network N such as the Internet and a local area network (LAN). In the following description, any terminal apparatus or terminal apparatuses among the plurality of terminal apparatuses 100a, 100b, 100c, 100d, etc. are referred to as a “terminal apparatus 100” or “terminal apparatuses 100”. The number of terminal apparatuses 100 illustrated in FIG. 1 is an example.

The communication support system 1 supports various types of communication in which at least a speech is transmitted and received between terminal apparatuses 100. Examples of the various types of communication include online business negotiations, face-to-face business negotiations, web conferences, face-to-face conferences, medical treatments such as remote medical consultations and face-to-face medical consultations, remote lectures, face-to-face lectures, counseling, and school consultations. In the following description, in one example, the communication support system 1 supports a web conference in which a participant (first participant) using a terminal apparatus 100 and another participant (second participant) using another terminal apparatus 100 transmit and receive video with speeches to and from each other and perform a business negotiation.

A terminal apparatus 100 is used by a participant participating in the web conference. Examples of the terminal apparatus 100 include general-purpose information terminals such as a personal computer (PC), a tablet terminal, and a smartphone. Alternatively, the terminal apparatus 100 may be a video conference device or an electronic device with web conferencing capability, such as an interactive white board (IWB). The IWB is an electronic whiteboard with the capability of interactive communication, and is also referred to as an electronic blackboard. In the following description, it is assumed that the terminal apparatus 100 is a general-purpose information terminal.

A participant who is to participate in the web conference uses, for example, a web conference application installed in the terminal apparatus 100 or a web browser to access a web conference address provided by the conference server 20 to participate in the web conference.

The communication support apparatus 10 is, for example, an information processing apparatus having the configuration of a computer or a system including a plurality of computers. The communication support apparatus 10 provides a communication support service according to the present embodiment.

The conference server 20 is an information processing apparatus having the configuration of a computer or a system including a plurality of computers. The conference server 20 provides a web conferencing service for transmitting and receiving speeches or video with speeches between multiple terminal apparatuses 100. In the present embodiment, the web conferencing service provided by the conference server 20 may be any web conferencing service.

The information terminal 101 is an information terminal such as a PC, a tablet terminal, or a smartphone used by, for example, an administrator who manages the communication support system 1 or a user who uses the communication support system 1. In one example, the administrator performs setting of the communication support apparatus 10 using, for example, a web browser included in the information terminal 101.

The system configuration of the communication support system 1 illustrated in FIG. 1 is an example.

In another example, as illustrated in FIG. 2, the communication support system 1 does not include the conference server 20. In a case where the communication support system 1 does not include the conference server 20, a terminal apparatus 100 may perform web conferencing using a web conferencing service external to the communication support system 1. Alternatively, the communication support apparatus 10 may have the functions of the conference server 20, and a terminal apparatus 100 may perform web conferencing using a web conferencing service provided by the communication support apparatus 10. Alternatively, the communication support system 1 may support communication in a typical conference between participants in the same conference room using the terminal apparatus 100a.

### Overview of Operation

For example, in a business negotiation using a web conference provided by the conference server 20, a sales representative (an example of a first participant) participating in the business negotiation may receive various questions from a client (an example of a second participant) participating in the business negotiation. In this case, the sales representative desires to acquire information supporting the business negotiation from various types of information, such as frequently asked questions (FAQs), a list of anticipated questions with answers, product information, or industry information, during the business negotiation to smoothly respond to, for example, questions from the client.

However, for example, in a technique disclosed in WO2019/220519, it is difficult for a user to acquire information supporting a business negotiation during the business negotiation because the user will not receive a desired answer unless the user explicitly asks a question of a FAQ system or the like. Such a problem is not limited to a conference system used for performing business negotiations. For example, various communication systems for providing communication such as remote medical consultations, counseling, remote lectures, or school consultations have this problem in common.

Accordingly, the communication support system 1 according to the present embodiment allows a participant participating in communication such as a business negotiation to easily obtain information supporting the communication during the communication.

For example, the communication support system 1 acquires a speech uttered by a participant participating in communication, and detects one or more predetermined keywords from the speech uttered by the participant in accordance with an utterance made by the participant. When a predetermined keyword is detected, the communication support system 1 provides information supporting the communication corresponding to the detected keyword.

Preferably, the communication support system 1 provides, as information supporting the communication, information corresponding to the detected keyword from a support database in which, for example, FAQs, a list of anticipated questions with answers, product information, or industry information is registered.

Preferably, the communication support system 1 acquires speeches uttered by participants who participate in the communication, from a terminal apparatus 100 used by a first participant (e.g., a sales representative) participating in the communication. Further, the communication support system 1 acquires, from the support database, information supporting the communication corresponding to a predetermined keyword detected from a speech uttered by a second participant (e.g., a client) among the acquired speeches uttered by the participants. Further, the communication support system 1 causes the terminal apparatus 100 used by the first participant to display the acquired information supporting the communication.

As described above, the present embodiment enables a participant participating in communication to easily obtain information supporting the communication during the communication.

### Hardware Configuration

### Hardware Configuration of Computer

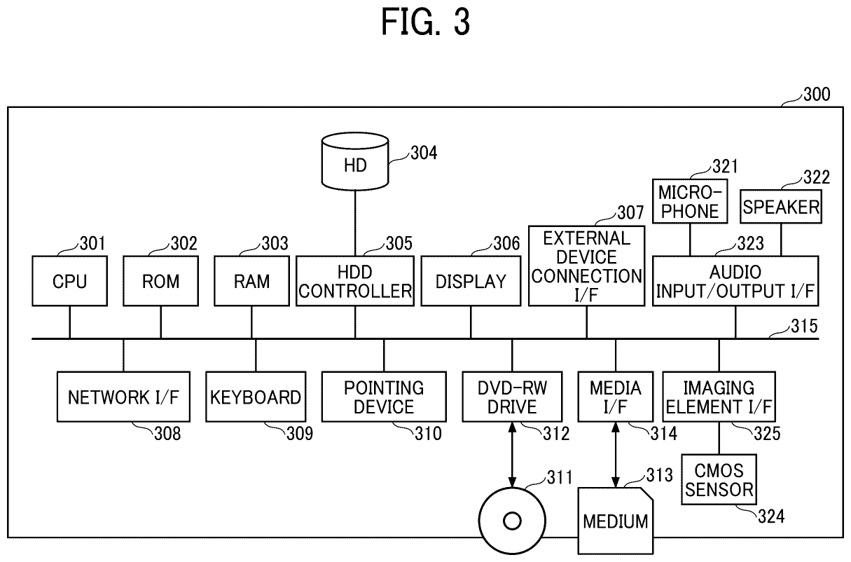

The communication support apparatus 10, the conference server 20, and the information terminal 101 have, for example, the hardware configuration of a computer 300 as illustrated in FIG. 3. Alternatively, the communication support apparatus 10 or the conference server 20 is implemented by a plurality of computers 300. In one example, the terminal apparatus 100 may have the hardware configuration of the computer 300 as illustrated in FIG. 3.

FIG. 3 is a diagram illustrating an example hardware configuration of a computer according to an embodiment. For example, as illustrated in FIG. 3, the computer 300 includes a central processing unit (CPU) 301, a read only memory (ROM) 302, a random access memory (RAM) 303, a hard disk (HD) 304, a hard disk drive (HDD) controller 305, a display 306, an external device connection interface (I/F) 307, a network I/F 308, a keyboard 309, a pointing device 310, a digital versatile disc rewritable (DVD-RW) drive 312, a media I/F 314, and a bus line 315.

When the computer 300 is the terminal apparatus 100, the computer 300 further includes, for example, a microphone 321, a speaker 322, an audio input/output I/F 323, a complementary metal oxide semiconductor (CMOS) sensor 324, and an imaging element I/F 325.

The CPU 301 controls the overall operation of the computer 300. The ROM 302 stores, for example, a program used for activating the computer 300, such as an initial program loader (IPL). The RAM 303 is used as a work area for the CPU 301, for example. The HD 304 stores, for example, programs such as an operating system (OS), an application, and a device driver, and various data. The HDD controller 305 controls, for example, reading or writing of various data from or to the HD 304 under the control of the CPU 301. The HD 304 and the HDD controller 305 are examples of a storage device included in the computer 300.

The display 306 displays various types of information such as a cursor, a menu, a window, text, or an image, for example. The display 306 may be external to the computer 300. The external device connection I/F 307 is an interface for connecting various external devices to the computer 300. The network I/F 308 is an interface for connecting the computer 300 to the communication network N to communicate with another apparatus.

The keyboard 309 is an example of an input means including a plurality of keys used to input, for example, characters, numerical values, and various instructions. The pointing device 310 is an example of an input means used to select or execute various instructions, select a target for processing, or move the cursor being displayed, for example. The keyboard 309 and the pointing device 310 may be external to the computer 300.

The DVD-RW drive 312 controls reading or writing of various data from or to a DVD-RW 311, which is an example of a removable recording medium. Instead of the DVD-RW 311, any other recording medium may be used. The media I/F 314 controls reading or writing (storing) of data from or to a medium 313 such as a flash memory. The bus line 315 includes an address bus, a data bus, various control signals, and the like for electrically connecting the components described above.

The microphone 321 is a built-in circuit that converts sound into an electrical signal. The speaker 322 is a built-in circuit that converts an electrical signal into physical vibration to generate sound such as music or voice. The audio input/output I/F 323 is a circuit that processes input and output of an audio signal between the microphone 321 and the speaker 322 under the control of the CPU 301.

The CMOS sensor 324 is an example of a built-in imaging means for capturing an image of an object (e.g., an image of the user) under the control of the CPU 301 to obtain image data. The computer 300 may include any other imaging means such as a charge coupled device (CCD) sensor instead of the CMOS sensor 324. The imaging element I/F 325 is a circuit that controls driving of the CMOS sensor 324.

### Example Hardware Configuration of Terminal Apparatus

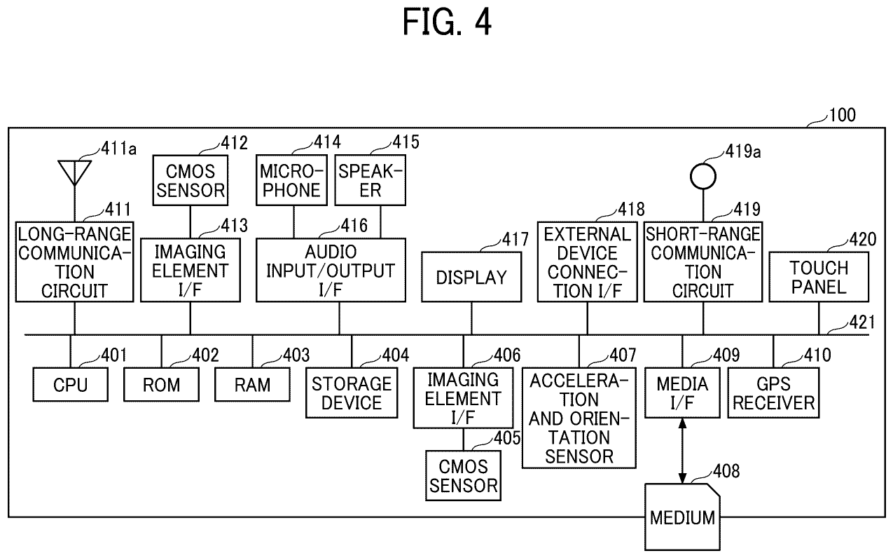

FIG. 4 is a diagram illustrating an example hardware configuration of the terminal apparatus 100 according to an embodiment. An example hardware configuration of the terminal apparatus 100, which is an information terminal such as a smartphone or a tablet terminal, will be described. The terminal apparatus 100 may be, for example, a video conference device or an electronic device having the configuration of a computer and web conferencing capability, such as an IWB. The terminal apparatus 100 may have the hardware configuration of the computer 300 as illustrated in FIG. 3.

In the example illustrated in FIG. 4, the terminal apparatus 100 includes, for example, a CPU 401, a ROM 402, a RAM 403, a storage device 404, a CMOS sensor 405, an imaging element I/F 406, an acceleration and orientation sensor 407, a media I/F 409, and a global positioning system (GPS) receiver 410.

The CPU 401 controls the overall operation of the terminal apparatus 100 by executing a predetermined program. The ROM 402 stores, for example, a program used for activating the CPU 401, such as an IPL. The RAM 403 is used as a work area for the CPU 401. The storage device 404 is a large-capacity storage device that stores, for example, an OS, a program such as an application, and various data, and is implemented by, for example, a solid state drive (SSD), a flash ROM, or the like.

The CMOS sensor 405 is an example of a built-in imaging means for capturing an image of an object (e.g., an image of the user) under the control of the CPU 401 to obtain image data. The terminal apparatus 100 may include any other imaging means such as a CCD sensor instead of the CMOS sensor 405. The imaging element I/F 406 is a circuit that controls driving of the CMOS sensor 405. Examples of the acceleration and orientation sensor 407 include, but are not limited to, an electromagnetic compass or gyrocompass for detecting geomagnetism and an acceleration sensor. The media I/F 409 controls reading or writing (storing) of data from or to a medium (storage medium) 408 such as a flash memory. The GPS receiver 410 receives a GPS signal (positioning signal) from a GPS satellite.

The terminal apparatus 100 further includes a long-range communication circuit 411, an antenna 411a of the long-range communication circuit 411, a CMOS sensor 412, an imaging element I/F 413, a microphone 414, a speaker 415, an audio input/output I/F 416, a display 417, an external device connection I/F 418, a short-range communication circuit 419, an antenna 419a of the short-range communication circuit 419, and a touch panel 420.

The long-range communication circuit 411 is a circuit that communicates with another apparatus via, for example, the communication network N. The CMOS sensor 412 is an example of a built-in imaging means for capturing an image of an object to obtain image data under the control of the CPU 401. The imaging element I/F 413 is a circuit that controls driving of the CMOS sensor 412. The microphone 414 is a built-in circuit that converts sound into an electrical signal. The speaker 415 is a built-in circuit that converts an electrical signal into physical vibration to generate sound such as music or voice. The audio input/output I/F 416 is a circuit that processes input and output of an audio signal between the microphone 414 and the speaker 415 under the control of the CPU 401.

The display 417 is an example of a display means such as a liquid crystal display (LCD) or an organic electroluminescence (EL) display for displaying an image of an object, various icons, or the like. The external device connection I/F 418 is an interface for connecting various external devices to the terminal apparatus 100. The short-range communication circuit 419 includes a circuit for performing short-range wireless communication. The touch panel 420 is an example of an input means that allows a user to operate the terminal apparatus 100 by touching a screen of the display 417.

The terminal apparatus 100 further includes a bus line 421. The bus line 421 includes an address bus, a data bus, various control signals, and the like for electrically connecting the components such as the CPU 401 illustrated in FIG. 4.

The hardware configuration of the terminal apparatus 100 illustrated in FIG. 4 is an example. The terminal apparatus 100 may have any other hardware configuration including, for example, the configuration of a computer, a communication circuit, a display, a microphone, and a speaker.

### Functional Configuration

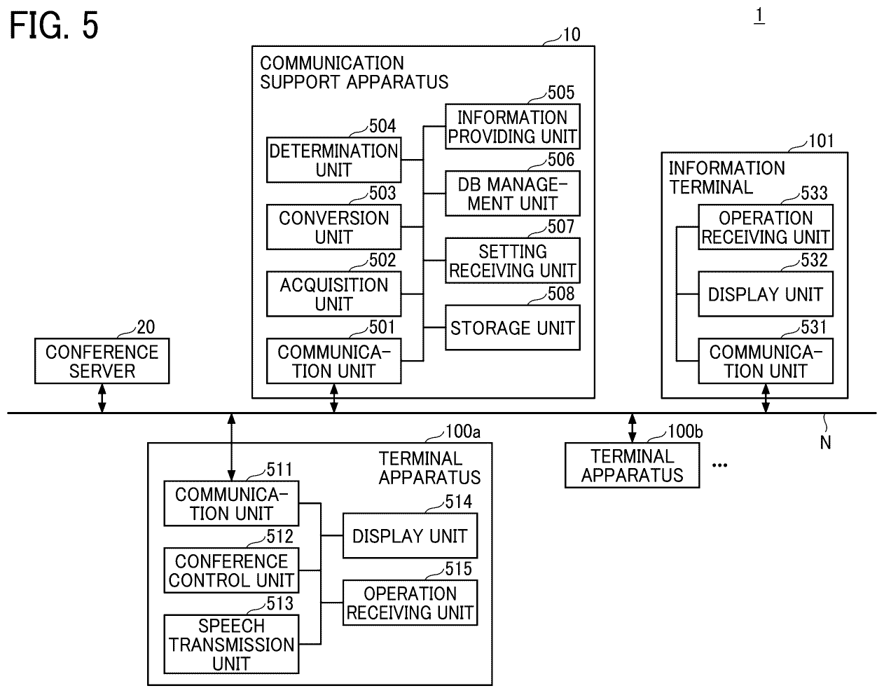

Next, the functional configuration of the communication support system 1 will be described. FIG. 5 is a diagram illustrating an example functional configuration of the communication support system 1 according to the first embodiment.

### Functional Configuration of Terminal Apparatus

In the following description, it is assumed that the terminal apparatus 100 has the hardware configuration of the computer 300 as illustrated in FIG. 3.

The terminal apparatus 100a, which is used by a first participant who participates in communication, implements, for example, functional components as illustrated in FIG. 5 by the CPU 301 executing a predetermined program. In the example illustrated in FIG. 5, the terminal apparatus 100a includes functional components such as a communication unit 511, a conference control unit 512, a speech transmission unit 513, a display unit 514, and an operation receiving unit 515. At least some of the functional components described above may be implemented by hardware.

In the present embodiment, the terminal apparatus 100b, which is used by a second participant who participates in the communication, may have any configuration that allows the second participant to participate in a web conference provided by the conference server 20 and transmit and receive speeches to and from the first participant.

The communication unit 511 executes a communication process for connecting the terminal apparatus 100a to the communication network N using, for example, the network I/F 308 to communicate with other apparatuses such as the communication support apparatus 10, the conference server 20, and the terminal apparatus 100b.

The conference control unit 512 executes a series of processes related to a web conference provided by the conference server 20, such as connecting to the web conference, transmitting and receiving a conference video (or conference audio), and inputting and outputting the conference video (or conference audio). The processes executed by the conference control unit 512 may be similar to those related to a typical web conference. The web conference is an example of communication according to the present embodiment.

The speech transmission unit 513 executes a speech transmission process for acquiring speeches uttered by participants who participate in the conference and transmitting the acquired speeches (audio data) to the communication support apparatus 10. The speeches uttered by the participants include, for example, a speech uttered by the first participant (e.g., a sales representative) who uses the terminal apparatus 100a, and a speech uttered by the second participant (e.g., a client) who uses the terminal apparatus 100b. In the present embodiment, the speeches uttered by the participants include at least the speech uttered by the second participant.

For example, the speech transmission unit 513 acquires a speech acquired by the audio input/output I/F 323 from the microphone 321 as the speech uttered by the first participant and a speech output from the speaker 322 by the audio input/output I/F 323 as the speech uttered by the second participant. In another example, the speech transmission unit 513 may acquire the speech uttered by the first participant or the speech uttered by the second participant from, for example, the conference control unit 512.

The display unit 514 executes, for example, a display process for displaying a display screen on the display 306 or the like. The operation receiving unit 515 executes an operation receiving process for receiving an operation performed by the first participant using, for example, an input device such as the keyboard 309 or the pointing device 310. For example, the operation receiving unit 515 receives a predetermined operation on an operation screen displayed by the display unit 514, and transmits operation information, which is information on the received predetermined operation, to the communication support apparatus 10 via the communication unit 511.

### Functional Configuration of Communication Support Apparatus

The communication support apparatus 10 implements, for example, functional components as illustrated in FIG. 5 by one or more computers 300 executing a predetermined program. In the example illustrated in FIG. 5, the communication support apparatus 10 includes functional components such as a communication unit 501, an acquisition unit 502, a conversion unit 503, a determination unit 504, an information providing unit 505, a database (DB) management unit 506, and a setting receiving unit 507. At least some of the functional components described above may be implemented by hardware.

The communication support apparatus 10 further includes a storage unit 508, which is implemented by, for example, storage devices such as the HD 304 and the HDD controller 305.

The communication unit 501 executes a communication process for connecting the communication support apparatus 10 to the communication network N using, for example, the network I/F 308 to communicate with other apparatuses such as the terminal apparatus 100b and the information terminal 101.

The acquisition unit 502 executes an acquisition process for acquiring speeches (audio data) uttered by participants who participate in the communication. For example, the acquisition unit 502 acquires speeches uttered by the participants, including the speech uttered by the first participant and the speech uttered by the second participant, which are transmitted from the speech transmission unit 513 of the terminal apparatus 100a used by the first participant to the communication support apparatus 10. It is assumed that the speeches uttered by the participants, which are transmitted to the communication support apparatus 10, include at least the speech uttered by the second participant.

The conversion unit 503 executes a conversion process for converting the speeches uttered by the participants, which are acquired by the acquisition unit 502, into text. For example, the conversion unit 503 converts the speech uttered by the first participant and the speech uttered by the second participant into text and stores the text-converted speeches in the storage unit 508 or the like. The conversion unit 503 converts at least the speech uttered by the second participant into text. The process for converting a speech into text is also referred to as “transcription” or “text conversion”.

The determination unit 504 executes a determination process for determining, in accordance with an utterance made by a participant, whether communication is to be supported, from a speech uttered by the participant. For example, in accordance with an utterance made by a participant, the determination unit 504 detects one or more predetermined keywords from a speech uttered by the participant. Preferably, the determination unit 504 detects, for each utterance made by the second participant, an extracted keyword registered in a support DB managed by the DB management unit 506 from within the text-converted speech uttered by the second participant. When one or more predetermined keywords are detected from a speech uttered by a participant, the determination unit 504 determines that communication is to be supported.

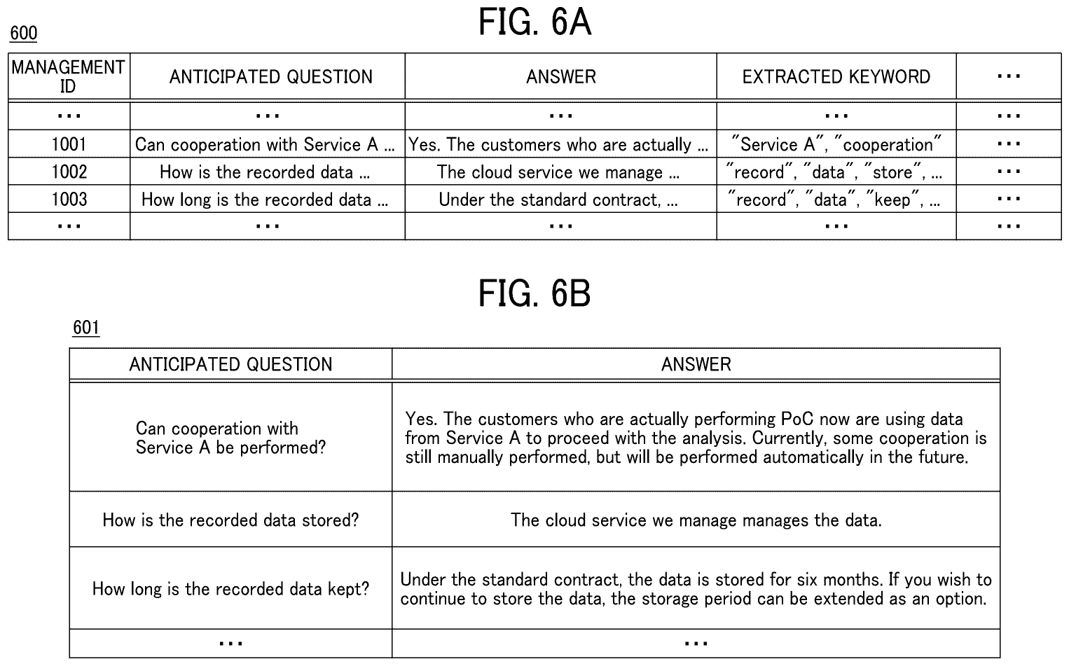

FIGS. 6A and 6B are illustrations of support databases according to the first embodiment. The DB management unit 506 of the communication support apparatus 10 manages, for example, a support DB 600 including items as illustrated in FIG. 6A.

In the example illustrated in FIG. 6A, the support DB 600 includes items of information such as “anticipated question”, “answer”, and “extracted keyword”. The “anticipated question” is a question anticipated in communication such as a business negotiation. The “answer” is an answer to the “anticipated question”. The “anticipated question” and the “answer” can be registered in the support DB 600 by, for example, an administrator who manages the communication support system 1 or a user who uses the communication support system 1, using the information terminal 101 or the like.

When the “anticipated question” and the “answer” are registered, the communication support apparatus 10 extracts one or more keywords from the “anticipated question” and registers the extracted one or more keywords in the “extracted keyword”. Examples of the “anticipated question” and the “answer” include an example of data 601 illustrated in FIG. 6B, in which a text (a character string or a sentence) registered as an “anticipated question” and an “answer” corresponding to the “anticipated question” are registered as text data.

When the determination unit 504 determines that the communication is to be supported, the information providing unit 505 executes an information providing process for providing information supporting the communication. For example, when a predetermined keyword is detected by the determination unit 504, the information providing unit 505 provides information supporting the communication corresponding to the detected predetermined keyword.

For example, it is assumed that the determination unit 504 detects predetermined keywords “Service A” and “cooperation”, which are registered in the “extracted keyword” of the support DB 600, from the speech uttered by the second participant. In this case, the information providing unit 505 provides, from the support DB 600, the anticipated question “Can cooperation with Service A be performed?” corresponding to the detected predetermined keywords and an answer corresponding to the anticipated question, as information supporting the communication. For example, the information providing unit 505 displays an anticipated question and an answer that correspond to a detected predetermined keyword on a display screen of an application executed by the terminal apparatus 100a used by the first participant.

The DB management unit 506 manages, for example, the support DB 600 including information as illustrated in FIG. 6A. The support DB 600 may be stored in the storage unit 508 or the like of the communication support apparatus 10 or may be stored in a cloud service or the like available via the communication network N.

The setting receiving unit 507 executes a setting receiving process for receiving various settings related to the communication support system 1 from, for example, the information terminal 101 or the terminal apparatus 100. For example, the setting receiving unit 507 receives registration of an “anticipated question” and an “answer” in the support DB 600, setting of the support DB 600, or the like.

The storage unit 508 stores, for example, various types of information such as a speech acquired by the acquisition unit 502, a speech converted into text by the conversion unit 503, the support DB 600, or setting information received by the setting receiving unit 507, and data.

### Functional Configuration of Information Terminal

The information terminal 101 implements, for example, a communication unit 531, a display unit 532, and an operation receiving unit 533 by one or more computers 300 executing a predetermined program. At least some of the functional components described above may be implemented by hardware.

The communication unit 531 executes a communication process for connecting the information terminal 101 to the communication network N using, for example, the network I/F 308 to communicate with other apparatuses.

The display unit 532 executes, for example, a display process for displaying a display screen or the like provided by the communication support apparatus 10 on the display 306 or the like. The operation receiving unit 533 executes, for example, an operation receiving process for receiving an operation such as input, setting, or selection on a display screen displayed by the display unit 532. The display unit 532 and the operation receiving unit 533 may be implemented by, for example, a web browser or the like included in the information terminal 101. For example, the information terminal 101 may be a general-purpose information terminal including a web browser.

The functional configuration of the communication support system 1 illustrated in FIG. 5 is an example. For example, the functions of the conference server 20 may be included in the communication support apparatus 10, or may be included in the computer 300 external to the communication support system 1, a cloud service, or the like. At least some of the functional components of the communication support apparatus 10 may be included in the terminal apparatus 100, the information terminal 101, or the like. The functional components of the communication support apparatus 10 may be arranged in a distributed manner in a plurality of information processing apparatuses. In short, each functional component of the communication support system 1 illustrated in FIG. 5 may be implemented by any one of the apparatuses included in the communication support system 1.

### Operation Flow

Next, the operation flow of a method for supporting communication according to the present embodiment will be described.

### Data Registration Process

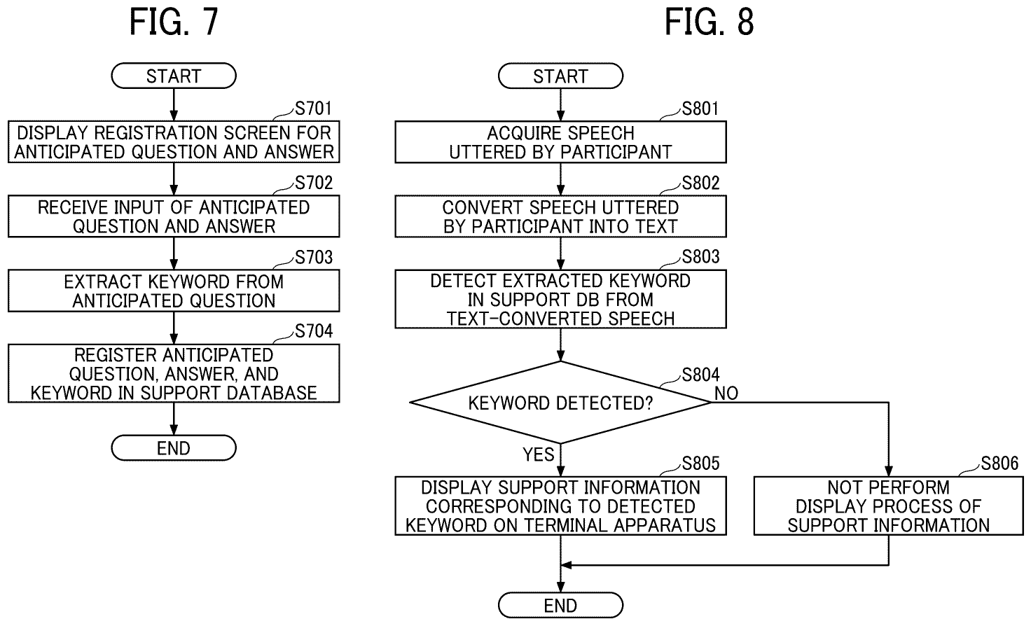

FIG. 7 is a flowchart illustrating an example of a data registration process according to the first embodiment. This process is an example of a data registration process in which, for example, an administrator who manages the communication support system 1 registers an anticipated question and an answer to the anticipated question in the support DB 600 using the information terminal 101. The data registration process may be executed by, for example, a user who uses the communication support system 1 using the terminal apparatus 100 or the like. In the following description, it is assumed that the administrator performs the data registration process using the information terminal 101.

In step S701, for example, the setting receiving unit 507 causes the information terminal 101 to display a registration screen for registering an anticipated question and an answer. For example, the administrator accesses a predetermined web page provided by the setting receiving unit 507 of the communication support apparatus 10 by using a web browser included in the information terminal 101 to display a registration screen for an anticipated question and an answer on the information terminal 101.

In step S702, the setting receiving unit 507 receives input of an anticipated question and an answer to the displayed registration screen.

In step S703, the setting receiving unit 507 extracts a keyword from the received anticipated question.

In step S704, the setting receiving unit 507 registers the input anticipated question and answer, and one or more keywords that have been extracted (extracted keywords) in the support DB 600.

Through the process illustrated in FIG. 7, the administrator can register an “anticipated question”, an “answer”, and an “extracted keyword” in the support DB 600 as illustrated in FIG. 6A.

The item names “anticipated question” and “answer” are examples. For example, the item “anticipated question” may be the item “anticipated utterance” or the like anticipated in the communication, and the item “answer” may be the item “response” or the like indicating a response to the “anticipated utterance”.

### Communication Support Process

FIG. 8 is a flowchart illustrating an example of a communication support process according to the first embodiment. This process is an example of a communication support process in which the communication support system 1 supports communication such as a web conference in which, for example, a first participant who uses the terminal apparatus 100a and a second participant who uses the terminal apparatus 100b participate. At the point in time when the process illustrated in FIG. 8 starts, it is assumed that the first participant and the second participant have participated in the same web conference using the terminal apparatus 100a and the terminal apparatus 100b, respectively. It is also assumed that the terminal apparatus 100a has executed an application program (hereinafter referred to as “application”) corresponding to the communication support system 1.

In step S801, the acquisition unit 502 acquires speeches uttered by the participants, which are transmitted from the terminal apparatus 100a used by the first participant. For example, the speech transmission unit 513 of the terminal apparatus 100a transmits speeches uttered by the participants, including the speech uttered by the first participant, which is acquired by the microphone 321, and the speech uttered by the second participant, which is output from the speaker 322, to the communication support apparatus 10. The acquisition unit 502 acquires the speeches uttered by the participants, which are transmitted from the terminal apparatus 100a, via the communication unit 501.

In step S802, the conversion unit 503 converts the speeches uttered by the participants, which are acquired by the acquisition unit 502, into text (text conversion). For example, the conversion unit 503 converts at least the speech uttered by the second participant among the speeches uttered by the participants into text.

In step S803, the determination unit 504 detects an extracted keyword in the support DB 600 from the text-converted speeches. Preferably, the determination unit 504 detects, for each utterance made by the second participant, one or more keywords registered in the “extracted keyword” of the support DB 600 from within the text-converted speech uttered by the second participant.

In step S804, the information providing unit 505 determines whether a keyword has been detected by the determination unit 504. If a keyword has been detected, the information providing unit 505 causes the process to proceed to step S805. On the other hand, if no keyword has been detected, the information providing unit 505 causes the process to proceed to step S806.

In step S805, the information providing unit 505 causes the terminal apparatus 100a used by the first participant to displays support information corresponding to the detected keyword.

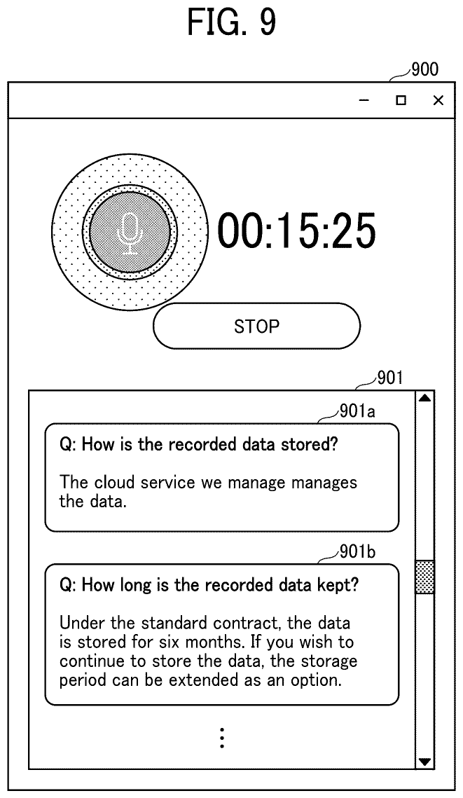

FIG. 9 is an illustration of an example of a display screen of support information according to the first embodiment. A display screen 900 illustrated in FIG. 9 is an example of an application screen displayed by the terminal apparatus 100a in step S805. The display screen 900 includes support information 901 provided by the information providing unit 505. The support information 901 is an example of information supporting communication corresponding to a detected predetermined keyword.

For example, if the keywords “record”, “data”, and “store” are detected from the speech uttered by the second participant, the information providing unit 505 causes the terminal apparatus 100a to display support information 901a as illustrated in FIG. 9, based on the support DB 600 as illustrated in FIG. 6A. If the keywords “record”, “data”, and “keep” are detected from the speech uttered by the second participant, the information providing unit 505 causes the terminal apparatus 100a to display support information 901b as illustrated in FIG. 9, based on the support DB 600.

On the other hand, if the process proceeds to step S806, the information providing unit 505 does not perform the process of displaying support information in step S805, and the process illustrated in FIG. 8 ends.

The communication support system 1 can support the communication in real time in accordance with an utterance made by the second participant, by repeatedly executing the process illustrated in FIG. 8. As used herein, the term “real time” refers to provision of support information in accordance with the progress of the communication. For example, a processing delay from an utterance made by the second participant to the display of support information is permissible.

### Modification of First Embodiment

As a modification, an example of a process performed when the DB management unit 506 manages a plurality of support databases will be described.

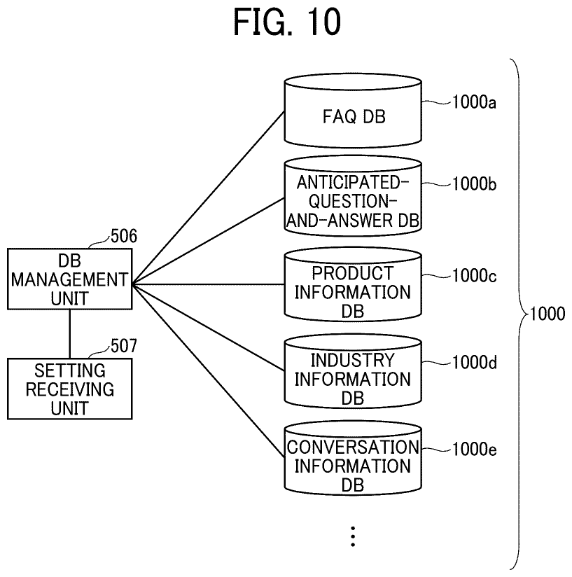

FIG. 10 is a diagram illustrating a support database according to a modification of the first embodiment. In the example illustrated in FIG. 10, the DB management unit 506 manages a plurality of support DBs 1000. The plurality of support DBs 1000 include, for example, a FAQ DB 1000a, an anticipated-question-and-answer DB 1000b, product information DB 1000c, industry information DB 1000d, and conversation information DB 1000e.

The FAQ DB 1000a is a database that can be collectively searched for questions related to products, services, supports, or the like, which are frequently asked by customers or the like, and answers to the questions. The anticipated-question-and-answer DB 1000b is a database that can be collectively searched for anticipated questions and answers to the questions in accordance with, for example, the content of communication such as business negotiations, remote medical consultations, counseling, remote lectures, or school consultations.

The product information DB 1000c is, for example, a database that can be collectively searched for anticipated questions and answers to the questions regarding a product that may be to be negotiated. The product information DB 1000c may be a service information DB that can be collectively searched for anticipated questions and answers to the questions regarding a service to be negotiated.

The industry information DB 1000d is, for example, a database that can be collectively searched for utterances related to a predetermined type of industry and topics related to the utterances. For example, a sales representative who is to have a business negotiation with a client in a different industry uses the industry information DB 1000d corresponding to the different industry to smoothly interact with the client regarding topics of the different industry. The conversation information DB 1000e is, for example, a database in which items of conversation (such as topics to be prepared in advance) corresponding to a conversation with the second participant are registered in advance. Each of the support DBs 1000 may have a configuration similar to that of the support DB 600 described in FIG. 6A, for example.

The setting receiving unit 507 receives the setting of, for example, a support DB 1000 in which the administrator registers an anticipated question and an answer, or a support DB 1000 to be searched in the communication support process illustrated in FIG. 8.

### Operation Flow

### Data Registration Process

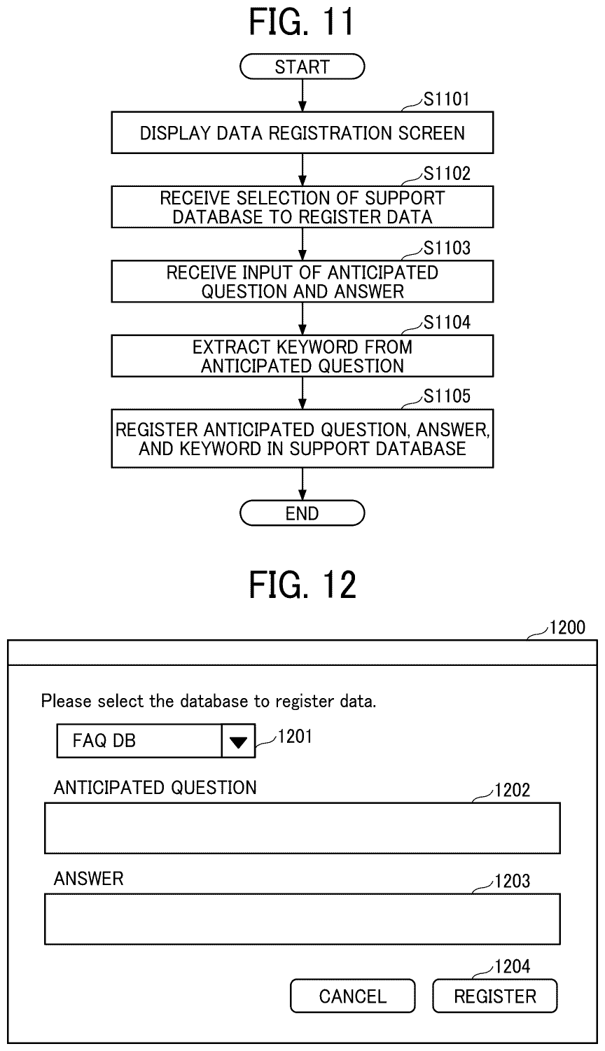

FIG. 11 is a flowchart illustrating an example of a data registration process according to the modification of the first embodiment. This process is another example of the data registration process in which, for example, an administrator who manages the communication support system 1 registers an anticipated question and an answer to the anticipated question in the support DB 600 using the information terminal 101. The content of the fundamental process is similar to that of the data registration process described with reference to FIG. 7, and the detailed description of the content of processing similar to that in the example illustrated in FIG. 7 will thus be omitted.

In step S1101, for example, the setting receiving unit 507 causes the information terminal 101 to display a data registration screen for registering an anticipated question and an answer. As an example, the setting receiving unit 507 causes the information terminal 101 to display a data registration screen 1200 as illustrated in FIG. 12.

FIG. 12 is an illustration of an example of a data registration screen according to the modification of the first embodiment. In the example illustrated in FIG. 12, the data registration screen 1200 displays a selection field 1201 for selecting a database to register data, an input field 1202 for inputting an anticipated question, an input field 1203 for inputting an answer, and a registration button 1204.

In step S1102, the setting receiving unit 507 receives selection of a support DB 1000 to register data. For example, the setting receiving unit 507 receives selection of a support DB 1000 using the selection field 1201 of the data registration screen 1200 as illustrated in FIG. 12. In the example illustrated in FIG. 12, the selection field 1201 provides a pull-down menu for selecting a support DB 1000 to register data. The support DB 1000 to register data may be selected using a method other than the pull-down menu, such as a checkbox or a radio button.

In step S1103, the setting receiving unit 507 receives input of an anticipated question and an answer. For example, the setting receiving unit 507 acquires an anticipated question input in the input field 1202 of the data registration screen 1200 and an answer input in the input field 1203.

In step S1104, the setting receiving unit 507 extracts a keyword from the received anticipated question.

In step S1105, the setting receiving unit 507 registers the input anticipated question and answer, and one or more keywords that have been extracted (extracted keywords) in the support DB 1000 selected in step S1102.

Through the process illustrated in FIG. 11, the administrator can register an “anticipated question”, an “answer”, and an “extracted keyword” in any desired support DB 1000.

### Support Database Selection Process

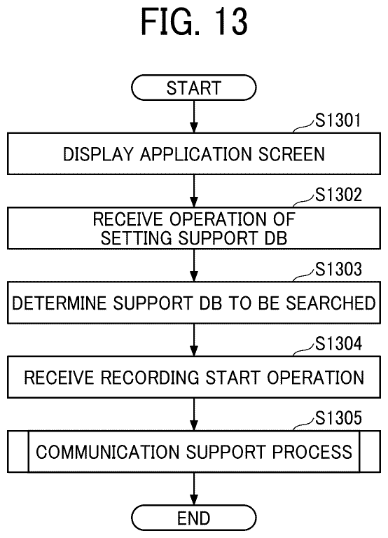

A communication support process according to the modification may be similar to the communication support process described with reference to FIG. 8. In the modification, a support database selection process as illustrated in FIG. 13 is performed before the communication support process illustrated in FIG. 8 is performed.

FIG. 13 is a flowchart illustrating an example of a support database selection process according to the modification of the first embodiment.

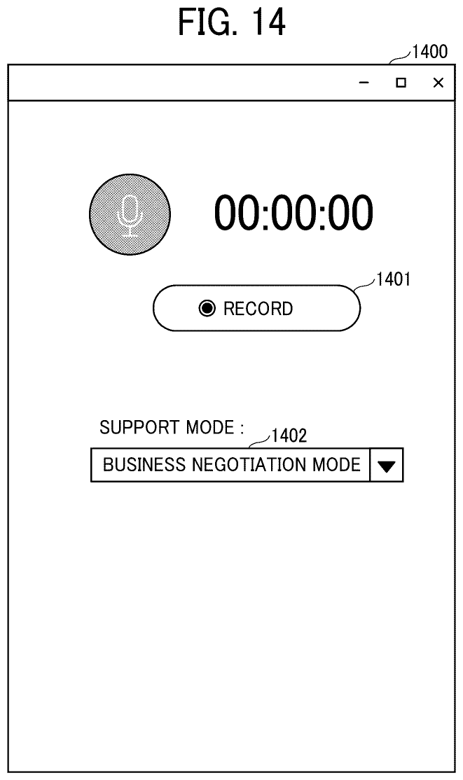

In step S1301, the display unit 514 of the terminal apparatus 100a used by the first participant displays, for example, an application screen (setting screen) 1400 as illustrated in FIG. 14 on the display 306 or the like.

FIG. 14 is an illustration of an example of an application screen according to the modification of the first embodiment. In the example illustrated in FIG. 14, the application screen 1400 displays, for example, a “Record” button 1401 for starting recording of a speech uttered by a participant, and a pull-down menu 1402 for selecting a support mode. The pull-down menu 1402 is an example of a selection field for selecting a support mode.

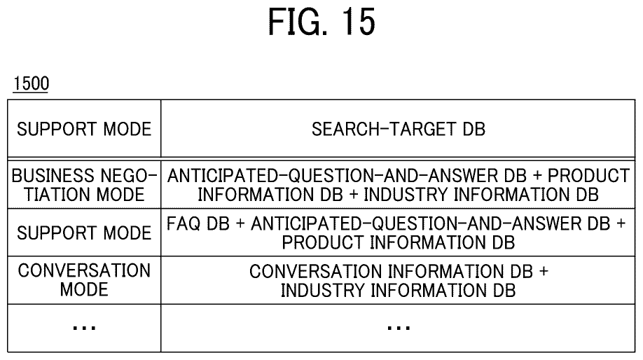

The communication support system 1 manages, for example, mode management information 1500 as illustrated in FIG. 15. The mode management information 1500 stores a plurality of support modes and search-target DBs corresponding to the support modes.

In the example illustrated in FIG. 15, for example, a business negotiation mode, a support mode, and a conversation mode are registered as support modes in the mode management information 1500. The mode management information 1500 indicates that, for example, when the business negotiation mode is selected, the search-target DBs are the anticipated-question-and-answer DB 1000b, the product information DB 1000c, and the industry information DB 1000d.

Preferably, for example, the mode management information 1500 can be registered by an administrator who manages the communication support system 1, using the information terminal 101.

In step S1302, the operation receiving unit 515 of the terminal apparatus 100a receives an operation performed by the first participant to set a support DB 1000. For example, the operation receiving unit 515 receives the setting of a support mode using the pull-down menu 1402 of the application screen 1400 as illustrated in FIG. 14.

In step S1303, the communication support system 1 determines a support DB 1000 to be searched from the received support mode and the mode management information 1500 as illustrated in FIG. 15. For example, in a case where the business negotiation mode is set, the communication support system 1 determines that the support DB 1000 to be searched is the anticipated-question-and-answer DB 1000b, the product information DB 1000c, and the industry information DB 1000d. The process may be performed by the setting receiving unit 507 of the communication support apparatus 10 or the operation receiving unit 515 of the terminal apparatus 100a.

In step S1304, the operation receiving unit 515 of the terminal apparatus 100a receives a recording start operation. Then, in step S1305, the communication support system 1 performs the communication support process described with reference to FIG. 8. In this case, for example, in step S803 in FIG. 8, the determination unit 504 detects an extracted keyword in the support DB 1000 determined to be searched, from the text-converted speeches.

Through the process illustrated in FIG. 13, the first participant can receive a communication support service based on a more appropriate support DB 1000 in accordance with the selected support mode.

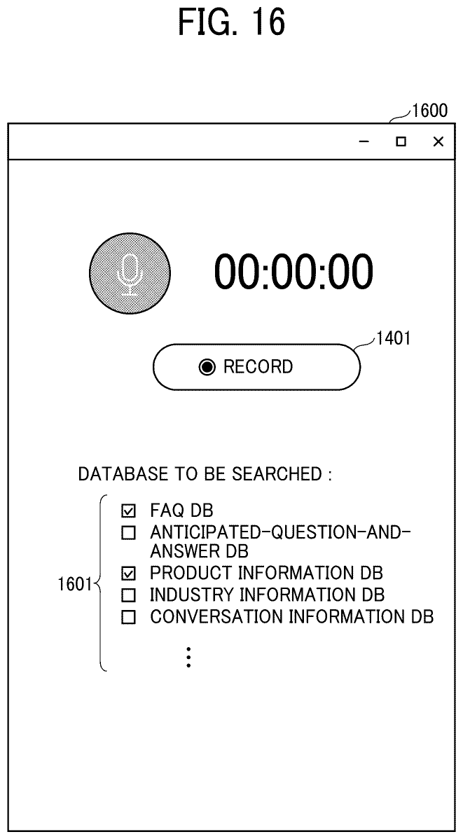

The application screen 1400 illustrated in FIG. 14 is an example. For example, in step S1301 illustrated in FIG. 13, the display unit 514 of the terminal apparatus 100a may display an application screen (setting screen) 1600 as illustrated in FIG. 16 on the display 306 or the like.

FIG. 16 is an illustration of another example of the application screen according to the modification of the first embodiment. In the example illustrated in FIG. 16, the application screen 1600 displays, for example, a “Record” button 1401 for starting recording of a speech uttered by a participant, and a checkbox 1601 for selecting a support DB 1000 to be searched. The first participant selects any of the checkboxes next to the names of the plurality of support DBs 1000. As a result, the first participant can set one or more support DBs 1000 to be searched.

As described above, according to the modification, the communication support system 1 can support communication using a more appropriate support DB 1000 among the plurality of support DBs 1000 managed by the DB management unit 506 in accordance with the communication.

As described above, the first embodiment enables a participant participating in communication to easily obtain information supporting the communication during the communication.

### Second Embodiment

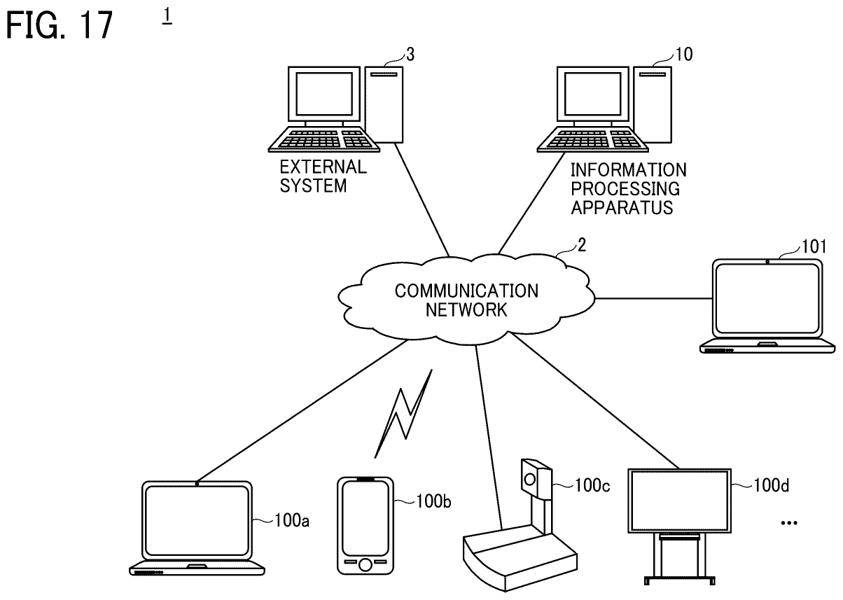

A second embodiment will be described with reference to FIGS. 17 to 34. A second embodiment will be described. In the second embodiment, the communication support system 1 and the communication support apparatus 10 are referred to as an information processing system 1 and an information processing apparatus 10, respectively. In the present embodiment, the information processing system 1 includes an external system 3 instead of the conference server 20. In the present embodiment, furthermore, the information terminal 101, which is operated by the administrator, is referred to as an administrator terminal 101.

The information processing system 1 evaluates an online business negotiation (hereinafter simply referred to as “business negotiation”), which is an example of communication performed between terminal apparatuses 100. The online business negotiation is an example and may be a face-to-face business negotiation. In the case of a face-to-face business negotiation, it is desirable that speeches uttered by participants who participate in the business negotiation be acquired by a single terminal apparatus 100.

The external system 3 provides, for example, an online conferencing service, a sales support service, or an emotion recognition service. For example, a participant who is to participate in the business negotiation accesses an online conferencing service provided by the external system 3 by using, for example, an online conference application installed in the terminal apparatus 100 or a web browser, and can thus have a business negotiation with another participant in an online conference. In the present embodiment, the online conferencing service provided by the external system 3 may be any online conferencing service.

The information processing apparatus 10 can acquire various types of information from a sales support service provided by the external system 3. Examples of the information include business negotiation matter information, customer information, and information on actions that sales members execute. The sales support service is a service for supporting sales activities and is also referred to as “sales force automation (SFA)”.

Further, the information processing apparatus 10 can acquire emotional information, such as the motivation of a participant participating in the business negotiation, using, for example, an emotion estimation service provided by the external system 3. The emotion estimation service is a service for estimating a change in emotion or mood from the voice, facial expression, or the like of a person by using, for example, an emotion estimation artificial intelligence (AI).

The information processing apparatus 10 is, for example, an information processing apparatus having the configuration of a computer, or a system including a plurality of computers.

The information processing apparatus 10 acquires speeches uttered by participants who participate in the business negotiation and evaluates the business negotiation based on the acquired speeches. Preferably, the information processing apparatus 10 provides, to an administrator or the like who manages a plurality of sales members, an analysis report that presents a member who is to receive guidance on business negotiations or a member whose motivation is to be taken care of, based on evaluation results of the plurality of sales members for the business negotiation.

The administrator terminal 101 is an information terminal such as a PC, a tablet terminal, or a smartphone used by the administrator or the like who manages the plurality of sales members. The administrator or the like can access the information processing apparatus 10 using the web browser or the like included in the administrator terminal 101 and display the evaluation results for the business negotiation, the analysis report, or the like provided by the information processing apparatus 10.

The system configuration of the information processing system 1 illustrated in FIG. 17 is an example. For example, at least some of the online conferencing service, the sales support service, and the emotion estimation service provided by the external system 3 may be included in the information processing apparatus 10. In this case, in a similar manner as described in FIG. 2, the information processing system 1 may not include the external system 3.

### Overview of Operation

In an existing technique disclosed in Japanese Unexamined Patent Application Publication No. 2004-318865, advice information related to the content of an activity of a participant who has participated in a business negotiation is generated based on the number of agreements reached in business negotiations. In actuality, however, even when a good business negotiation is performed, no agreement may be reached. Thus, the existing technique makes it difficult to appropriately evaluate a business negotiation when the business negotiation ends in failure.

Accordingly, the information processing system 1 according to the second embodiment acquires a speech uttered by a participant (sales member) who participates in a business negotiation and a speech uttered by another participant (customer) who participates in the business negotiation, and calculates an index indicating an utterance state in the business negotiation, based on the acquired speeches. For example, the information processing system 1 calculates, based on the number of turns of speeches uttered during a business negotiation, an index indicating the utterance state in the business negotiation (e.g., a turn density given by the number of turns per minute).

Further, the information processing system 1 evaluates a failed business negotiation, based on a comparison result between the calculated index and a reference index. The reference index is, for example, an index (e.g., a turn density or the like) indicating the utterance state in the business negotiation and calculated from a plurality of business negotiations performed by a sales member or the like having high sales performance.

Preferably, the information processing system 1 evaluates a failed business negotiation, based on a comparison result between the calculated index and the reference index and based on lead quality of the business negotiation, namely, a hot lead or a cold lead. The term “hot lead” refers to a lead (potential customer) who is highly interested in a product (commodity or service) to be negotiated and is likely to sign a sales agreement soon. In contrast, the term “cold lead” refers to a lead who has little or no interest in a product to be negotiated and expresses low willingness to purchase the product at the current point in time.

Alternatively, the information processing system 1 may evaluate a failed business negotiation, based on the comparison result between the calculated index and the reference index and based on the reason for the failure of the business negotiation.

Accordingly, when a business negotiation ends in failure, the information processing system 1 can more appropriately evaluate the failed business negotiation.

### Hardware Configuration

### Hardware Configuration of Computer

The external system 3, the information processing apparatus 10, and the administrator terminal 101 have, for example, the hardware configuration of the computer 300 as illustrated in FIG. 3. The external system 3 and the information processing apparatus 10 may be implemented by a plurality of computers 300. In one example, the terminal apparatus 100 may have the hardware configuration of the computer 300 as illustrated in FIG. 3.

The administrator terminal 101 may have the hardware configuration of the terminal apparatus 100 as illustrated in FIG. 4.

### Functional Configuration

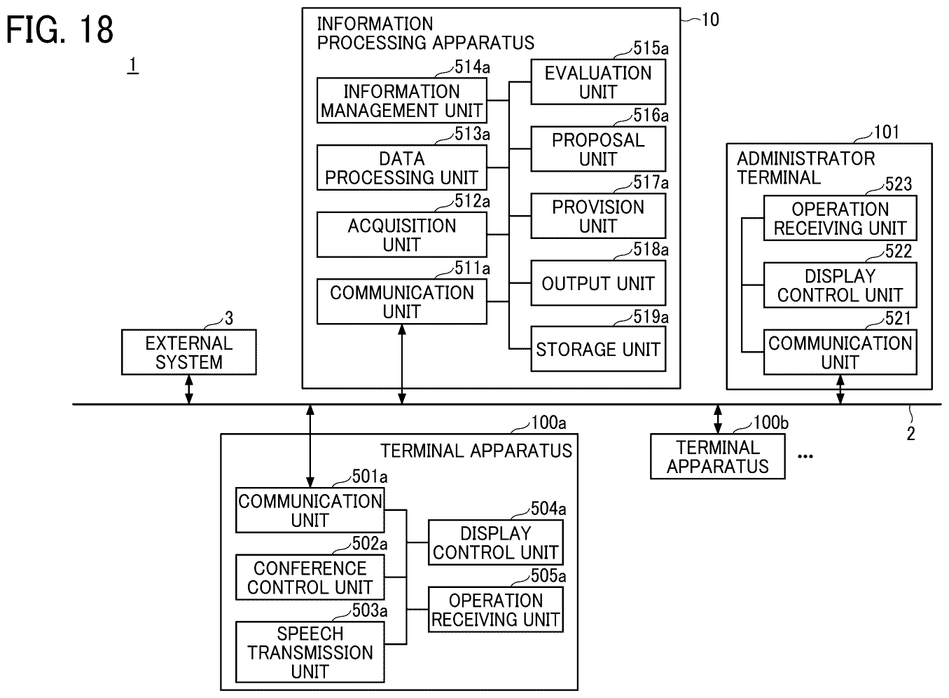

Next, an example functional configuration of the information processing system 1 will be described. FIG. 18 is a diagram illustrating an example functional configuration of the information processing system 1 according to the second embodiment. In the following description, it is assumed that the information processing system 1 has the system configuration as illustrated in FIG. 17.

### Functional Configuration of Terminal Apparatus

In the following description, it is assumed that the terminal apparatus 100 has the hardware configuration of the computer 300 as illustrated in FIG. 3.

The terminal apparatus 100 implements, for example, the functional components of the terminal apparatus 100 as illustrated in FIG. 18 by the CPU 301 executing a program stored in a storage medium such as the HD 304, the DVD-RW 311, or the medium 313. In the example illustrated in FIG. 18, the terminal apparatus 100a includes, for example, a communication unit 501a, a conference control unit 502a, a speech transmission unit 503a, a display control unit 504a, and an operation receiving unit 505a. At least some of the functional components described above may be implemented by hardware. In FIG. 18, the terminal apparatuses 100b, etc. may have any functional configuration that enables the terminal apparatuses 100b, etc. to have an online conference with the terminal apparatus 100a via, for example, a communication network 2 and the external system 3.

The communication unit 501a executes a communication process for connecting the terminal apparatus 100a to the communication network 2 using, for example, the network I/F 308 to communicate with another apparatus such as the external system 3, the information processing apparatus 10, or any other terminal apparatus 100.

The conference control unit 502a executes a series of processes related to an online conference, such as connecting to the online conference, transmitting and receiving a conference video (or conference audio) of the online conference, and inputting and outputting the conference video (or conference audio). The processes executed by the conference control unit 502a may be similar to those related to a typical online conference.

The speech transmission unit 503a executes a speech transmission process for acquiring a speech uttered by a participant who participates in a business negotiation using an online conference and a speech uttered by another participant who participates in the business negotiation, and transmitting the speeches to the information processing apparatus 10. For example, the speech transmission unit 503a acquires, from the audio input/output I/F 323 or the like, a speech acquired by the microphone 321 (the speech uttered by the participant) and a speech output from the speaker 322 (the speech uttered by the other participant), and transmits the acquired speeches (audio data) to the information processing apparatus 10.

Accordingly, the information processing apparatus 10 can acquire a speech uttered by a participant who participates in a business negotiation using any online conferencing service and a speech uttered by another participant who participates in the business negotiation.

In another example, the speech transmission unit 503a may acquire the speech uttered by the participant or the speech uttered by the other participant from, for example, the conference control unit 502a and transmit the acquired speeches (audio data) to the information processing apparatus 10. The speech transmission unit 503a is implemented by, for example, the CPU 301 executing an application program (hereinafter referred to as “application”) for the information processing system 1.

The display control unit 504a executes, for example, a display control process for controlling a display unit such as the display 306 to display a display screen. The operation receiving unit 505a executes an operation receiving process for receiving an operation performed by the participant using, for example, an input device such as the keyboard 309 or the pointing device 310. The conference control unit 502a, the display control unit 504a, and the operation receiving unit 505a are implemented by, for example, a web browser or the like included in the terminal apparatus 100a.

### Functional Configuration of Information Processing Apparatus

The information processing apparatus 10 implements, for example, the functional components of the information processing apparatus 10 as illustrated in FIG. 18 by the CPU 301 or the like executing a program stored in a storage medium such as the HD 304, the DVD-RW 311, or the medium 313. In the example illustrated in FIG. 18, the information processing apparatus 10 includes functional components such as a communication unit 511a, an acquisition unit 512a, a data processing unit 513a, an information management unit 514a, an evaluation unit 515a, a proposal unit 516a, a provision unit 517a, and an output unit 518a. At least some of the functional components described above may be implemented by hardware.

The information processing apparatus 10 further includes a storage unit 519a, which is implemented by, for example, storage devices such as the HD 304 and the HDD controller 305.

The communication unit 511a executes a communication process for connecting the information processing apparatus 10 to the communication network 2 using, for example, the network I/F 308 to communicate with other apparatuses such as the terminal apparatus 100 and the administrator terminal 101.

The acquisition unit 512a executes an acquisition process for acquiring speeches (audio data) uttered by a participant and another participant who participate in communication. In one specific example, when the communication is a business negotiation, the acquisition unit 512a acquires speeches uttered by a participant and another participant who participate in the business negotiation. For example, the acquisition unit 512a acquires a speech uttered by a participant who uses the terminal apparatus 100a and a speech uttered by another participant, which are transmitted from the speech transmission unit 503a of the terminal apparatus 100a.

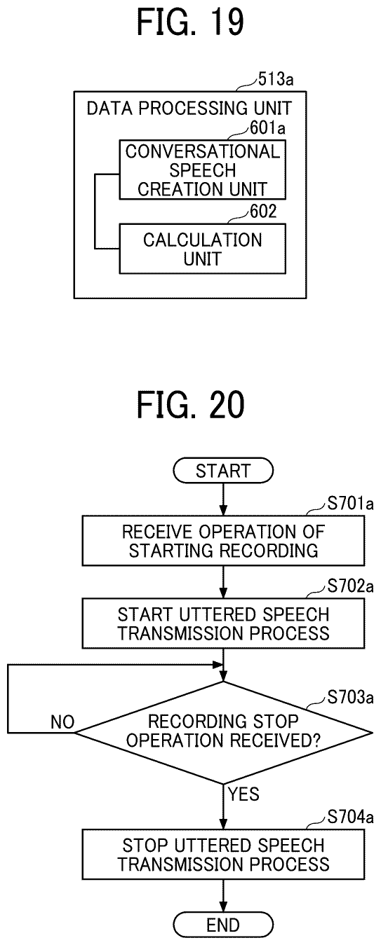

The data processing unit 513a executes data processing on the speeches (audio data) uttered by the participant and the other participant, which are acquired by the acquisition unit 512a. For example, as illustrated in FIG. 19, the data processing unit 513a includes a conversational speech creation unit 601a and a calculation unit 602.

The conversational speech creation unit 601a executes a conversational speech creation process for combining the speech uttered by the participant and the speech uttered by the other participant, which are acquired by the acquisition unit 512a, to create a conversational speech including the speech uttered by the participant and the speech uttered by the other participant.

The calculation unit 602 executes a calculation process for calculating an index indicating the utterance state in the communication, based on the speeches uttered by the participant and the other participant, which are acquired by the acquisition unit 512a. In one specific example, when the communication is a business negotiation, the calculation unit 602 calculates an index indicating the utterance state in the business negotiation, based on the speeches uttered by the participant and the other participant, which are acquired by the acquisition unit 512a. For example, the calculation unit 602 calculates the number of turns of speeches in the business negotiation (communication), the turn density (the number of turns per minute), and the like from the conversational speech created by the conversational speech creation unit 601a. As used herein, the term “turn” refers to a single utterance from the beginning to the end of the utterance produced by a single speaker, and is also referred to as “speaker change” or “uttering order”.

Further, the calculation unit 602 calculates the speech volume of the participant and the speech volume of the other participant from the conversational speech created by the conversational speech creation unit 601a. Preferably, the calculation unit 602 calculates a moving average of the speech volume of the participant and the speech volume of the other participant over a predetermined period of time (e.g., a period of about several seconds to dozen or so minutes) to calculate the speech volume of the participant and the speech volume of the other participant for each predetermined period of time. The turn density and the speech volume are examples of an index indicating the utterance state in the communication.

The information management unit 514a executes an information management process for acquiring various types of information, such as business negotiation matter information, customer information, or information on actions that sales members execute, from a sales support service or the like provided by the external system 3 and storing the acquired information in the storage unit 519a or the like.

The evaluation unit 515a executes an evaluation process for evaluating the communication, based on the result of the communication and a comparison result between an index indicating the utterance state in the communication, which is calculated by the calculation unit 602, and a reference index. For example, in a case where the result of the communication is not favorable (or is unsuccessful), the evaluation unit 515a executes an evaluation process for evaluating the communication, based on the comparison result between the calculated index indicating the utterance state in the communication and the reference index.

For example, when the communication is a business negotiation, the evaluation unit 515a evaluates the business negotiation, based on the result of the business negotiation and the comparison result between the calculated index and the reference index. In one specific example, in a case where the business negotiation has failed, the evaluation unit 515a evaluates the business negotiation, based on a comparison result between the turn density in the business negotiation and a reference turn density and based on the reason for the failure of the business negotiation. Alternatively, in a case where the business negotiation has failed, the evaluation unit 515a may evaluate the business negotiation, based on the comparison result between the turn density in the business negotiation and the reference turn density and based on lead quality of the business negotiation, namely, a hot lead or a cold lead. The details of the evaluation process executed by the evaluation unit 515a will be described below.

Examples of the case where the result of the communication is not favorable (or is unsuccessful) include, but are not limited to, a failed business negotiation, an unsuccessful conference, and re-execution of counseling.

The proposal unit 516a proposes management for a participant, based on evaluation results obtained by the evaluation unit 515a evaluating a plurality of business negotiations in which the participant has participated. For example, the proposal unit 516a extracts a business negotiation to be managed from among a plurality of business negotiations, based on the evaluation results of the plurality of business negotiations in which the participant has participated, and proposes management for the participant, based on the business negotiation to be managed.

For example, the proposal unit 516a presents to the administrator or the like an analysis report that proposes guidance to a member who is to receive guidance on business negotiations among a plurality of members managed by the administrator or the like. Further, the proposal unit 516a presents to the administrator or the like an analysis report that proposes care for a member who has participated in a business negotiation that is conducted well but ends in failure among the plurality of members managed by the administrator or the like.

The provision unit 517a executes a providing process for providing a display screen on which the utterance state of the participant and the utterance state of the other participant are displayed in time series, based on the speeches uttered in the business negotiation to be managed extracted by the proposal unit 516a. For example, the provision unit 517a causes the administrator terminal 101 or the like to display a display screen on which the speech volume of the participant and the speech volume of the other participant are displayed in time series. The speech volume is an example of the utterance state. The utterance state may be represented by, for example, a speech rate, a conversation density, or a turn density.

The output unit 518a executes an output process for outputting the content of an utterance of a selected portion from the utterance states of the participant and the other participant, which are displayed on the display screen by the provision unit 517. For example, the output unit 518a reproduces the uttered speech of the selected portion from the utterance states of the participant and the other participant. Instead of (or in addition to) reproduction of an uttered speech, the output unit 518 may display a character string that is the converted text of the uttered speech, for example, in a chat format.

The storage unit 519a stores, for example, various types of information, data, and a program. Examples of the information include an uttered speech acquired by the acquisition unit 512a, a conversational speech and an index created by the data processing unit 513a, information acquired by the information management unit 514a, and an evaluation result obtained by the evaluation unit 515a.

### Functional Configuration of Administrator Terminal

The administrator terminal 101 implements, for example, the functional components of the administrator terminal 101 as illustrated in FIG. 18 by the CPU 301 executing a program stored in a storage medium such as the HD 304, the DVD-RW 311, or the medium 313. In the example illustrated in FIG. 18, the administrator terminal 101 includes functional components of the administrator terminal 101, such as a communication unit 521, a display control unit 522, and an operation receiving unit 523. At least some of the functional components described above may be implemented by hardware.

The communication unit 521 executes a communication process for connecting the administrator terminal 101 to the communication network 2 using, for example, the network I/F 308 to communicate with, for example, another apparatus such as the information processing apparatus 10.

The display control unit 522 executes, for example, a display control process for controlling a display unit such as the display 306 to display a display screen provided from, for example, the information processing apparatus 10. The operation receiving unit 523 executes, for example, an operation receiving process for receiving an operation performed by, for example, the administrator on the display screen displayed by the display control unit 522. The display control unit 522 and the operation receiving unit 523 may be implemented by, for example, a web browser or the like included in the administrator terminal 101. For example, the administrator terminal 101 may be a general-purpose information terminal or the like including a web browser.

The functional configuration of the information processing system 1 illustrated in FIG. 18 is an example. For example, the information processing apparatus 10 may have the functions of the external system 3. At least some of the functional components of the information processing apparatus 10 may be included in the terminal apparatus 100, the administrator terminal 101, or the like. At least some of the functional components of the terminal apparatus 100 may be included in the information processing apparatus 10, the external system 3, or the like. In short, each functional component of the information processing system 1 illustrated in FIG. 18 may be implemented by any one of the apparatuses included in the information processing system 1.

### Operation Flow

Next, the operation flow of an information processing method according to the present embodiment will be described.

### Process Performed by Terminal Apparatus

FIG. 20 is a flowchart illustrating an example of a process performed by the terminal apparatus 100 according to the second embodiment. This process is an example of a process performed by, for example, the terminal apparatus 100 (e.g., the terminal apparatus 100a) having the functional configuration illustrated in FIG. 18. At the point in time when the process illustrated in FIG. 20 starts, it is assumed that the terminal apparatus 100 (e.g., the terminal apparatus 100a) used by a participant has participated in the same business negotiation using an online conference as the terminal apparatus (e.g., the terminal apparatus 100b) used by another participant and can have at least a conversation by voice.

In step S701a, in response to the operation receiving unit 505a receiving an operation of starting recording of a conversational speech, the terminal apparatus 100 executes the processing of step S702a and the subsequent processing.

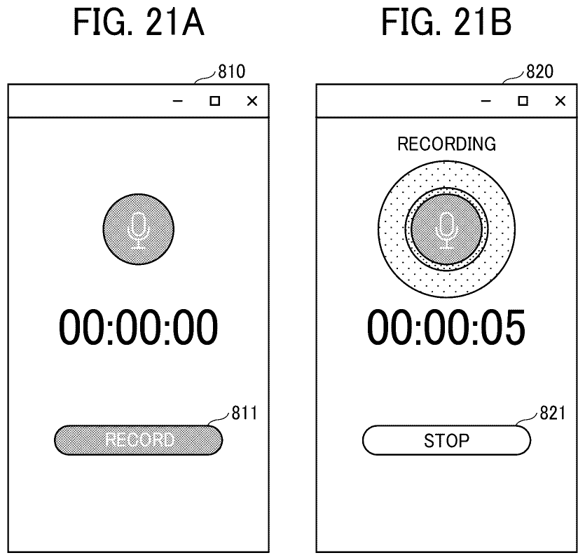

FIGS. 21A and 21B are illustrations of an example of operation screens on the terminal apparatus 100 according to the second embodiment. In one embodiment, the terminal apparatus 100 executes an application corresponding to the information processing system 1 to display, for example, an operation screen as illustrated in FIG. 21A or 21B. For example, the participant selects a “Record” button 811 on an operation screen 810 as illustrated in FIG. 21A to perform an operation of starting recording of a conversational speech.

In step S702a, the speech transmission unit 503a acquires a speech uttered by a participant participating in a business negotiation and a speech uttered by another participant participating in the business negotiation, and starts an uttered speech transmission process for transmitting the acquired speeches to the information processing apparatus 10.

In step S703a, the operation receiving unit 505a determines whether a recording stop operation is received. In a case where the participant selects the “Record” button 811 on the operation screen 810 as illustrated in FIG. 21A, the terminal apparatus 100 displays, for example, an operation screen 820 as illustrated in FIG. 21B. For example, the participant selects a “Stop” button 821 on the operation screen 820 as illustrated in FIG. 21B to perform an operation of stopping the recording.

If the recording stop operation is received, the operation receiving unit 505a causes the process to proceed to step S704a. On the other hand, if the recording stop operation is not received, for example, the operation receiving unit 505a repeatedly executes the processing of step S703a.

In step S704a, the speech transmission unit 503a stops or ends the uttered speech transmission process. Through the process illustrated in FIG. 20, the terminal apparatus 100 can transmit the speeches uttered by the participant and the other participant to the information processing apparatus 10.

### Data Processing

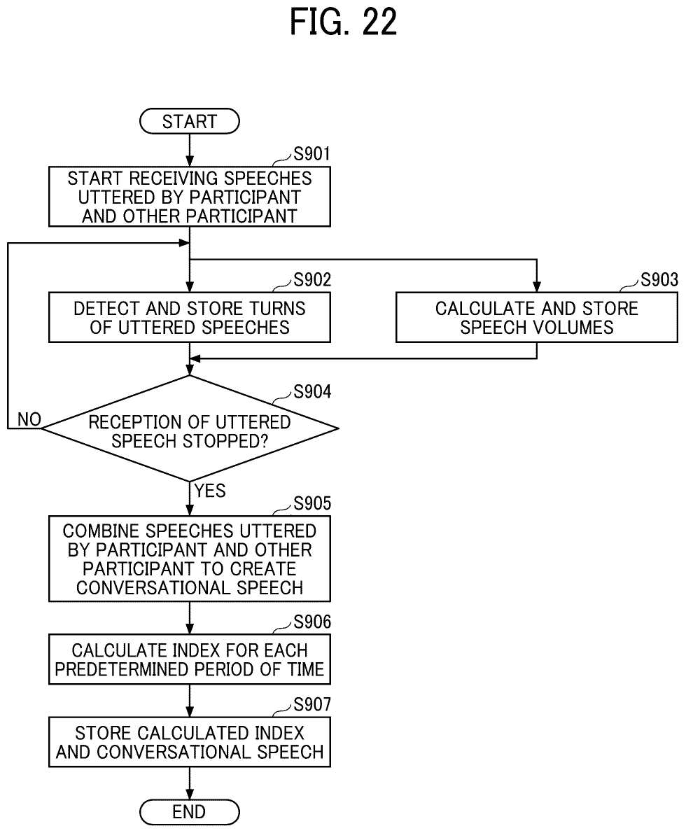

FIG. 22 is a flowchart illustrating an example of data processing according to the second embodiment. This process is an example of data processing executed by the information processing apparatus 10 in response to receipt of, for example, a speech uttered by the participant and a speech uttered by the other participant transmitted from the terminal apparatus 100 to the information processing apparatus 10 through the process of the terminal apparatus 100 illustrated in FIG. 20.

In step S901, when the acquisition unit 512a starts receiving the speeches uttered by the participant and the other participant transmitted from the terminal apparatus 100, the information processing apparatus 10 executes the processing of step S902 and the subsequent processing.

In step S902, the data processing unit 513a detects and stores turns of speeches uttered by the participant and the other participant acquired by the acquisition unit 512a. For example, the data processing unit 513a detects, as one turn, one utterance from the speeches uttered by the participant and the other participants, and stores the turn, with a time stamp, in the storage unit 519 or the like.

In step S903, for example, in parallel with the processing of step S902, the data processing unit 513a calculates and stores the speech volumes of the speeches uttered by the participant and the other participant acquired by the acquisition unit 512a. For example, the data processing unit 513a stores the calculated speech volumes, with time stamps, in the storage unit 519 or the like.

In step S904, the acquisition unit 512a determines whether the reception of an uttered speech has been stopped. If the reception of an uttered speech has not been stopped, the information processing apparatus 10 again executes the processing of steps S902 to S904. On the other hand, if the reception of an uttered speech has been stopped, the acquisition unit 512a causes the process to proceed to step S905.

In step S905, the data processing unit 513a combines the speech uttered by the participant and the speech uttered by the other participant, which are acquired by the acquisition unit 512a, to create a conversational speech including the speech uttered by the participant and the speech uttered by the other participant.

In step S906, the data processing unit 513a calculates an index indicating the utterance states of the participant and the other participant. For example, at each point in time of the business negotiation, the data processing unit 513a calculates a moving average over a predetermined period of time from speech volume data of the participant to calculate the speech volume of the participant for each predetermined period of time. Likewise, at each point in time of the business negotiation, the data processing unit 513a calculates a moving average over a predetermined period of time from speech volume data of the other participant to calculate the speech volume of the other participant for each predetermined period of time.

Further, the data processing unit 513a calculates a turn density, which is the number of turns per unit time (e.g., the number of turns per minute), from the data of the turns of the uttered speeches stored in the storage unit 519 or the like. The speech volume of the participant per predetermined time, the speech volume of the other participant per predetermined time, and the turn density are examples of an index indicating the utterance states of the participant and the other participant.

In step S907, the data processing unit 513a stores the calculated index and the created conversational speech in the storage unit 519 or the like.

Through the process illustrated in FIG. 22, the information processing apparatus 10 can acquire speeches uttered by the participant and the other participant participating in the business negotiation and an index or the like indicating the speech states of the participant and the other participant and store the acquired information in the storage unit 519 or the like.

Next, an evaluation process according to the second embodiment will be described.

### Evaluation Process 1

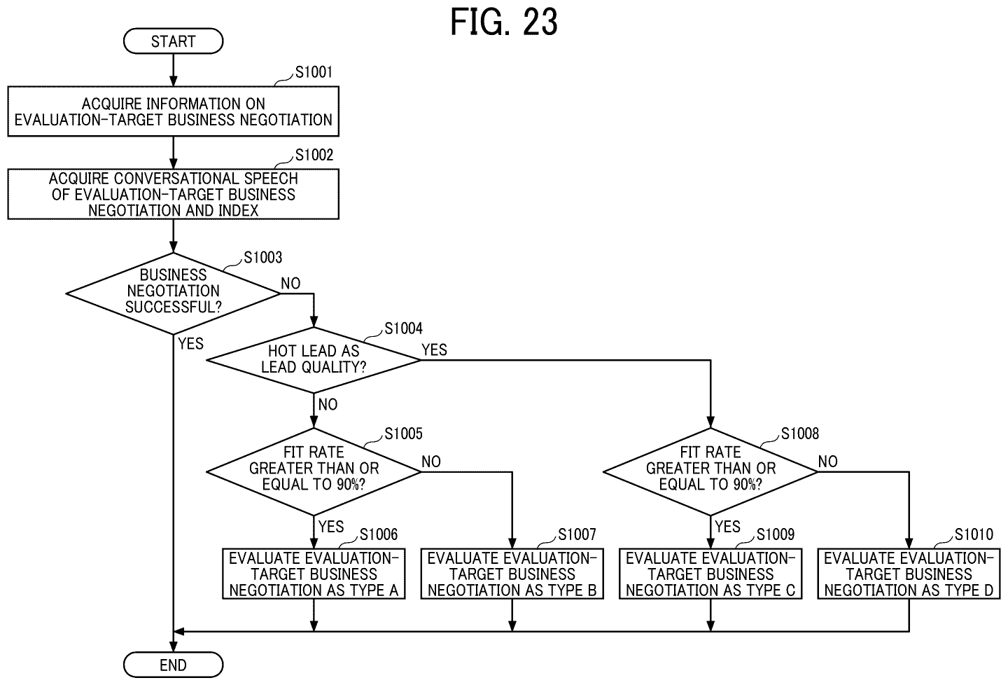

FIG. 23 is a flowchart illustrating an example of the evaluation process according to the second embodiment. This process is an example of an evaluation process in which the information processing apparatus 10 evaluates an evaluation-target business negotiation to be evaluated. It is assumed that, at the point in time at which the process illustrated in FIG. 23 starts, the information processing apparatus 10 has already executed the data processing illustrated in FIG. 22.

In step S1001, the evaluation unit 515a of the information processing apparatus 10 acquires, from the information management unit 514a, information on the evaluation-target business negotiation. The information on the business negotiation includes, for example, information on a participant (sales representative) who participated in the business negotiation and another participant (customer) who participated in the business negotiation, and information such as the result of the business negotiation (whether the business negotiation ends in success or failure, and if the business negotiation ends in failure, the reason for the failure).

In step S1002, the evaluation unit 515a acquires, from the storage unit 519 or the like, a conversational speech in the evaluation-target business negotiation and an index.

In step S1003, the evaluation unit 515a determines, based on the acquired information on the business negotiation, whether the business negotiation is successful. If the business negotiation is successful, for example, the evaluation unit 515a does not perform evaluation, and the process illustrated in FIG. 23 ends. On the other hand, if the business negotiation is not successful (if the business negotiation ends in failure), the evaluation unit 515a causes the process to proceed to step S1004.

In step S1004, the evaluation unit 515a determines a hot lead as the lead quality of the business negotiation, based on the acquired information.

As an example, the evaluation unit 515a determines, based on the reason for the failure of the business negotiation included in the acquired information on the business negotiation, whether the lead (potential customer) is a hot lead who expresses a high purchase willingness or a cold lead who expresses a low purchase willingness. For example, if the business negotiation has failed due to some contract terms such as “cost”, “the contract period being unsatisfactory”, “media being under contract with another company”, or “no employment records of foreigners”, the evaluation unit 515a determines a hot lead. On the other hand, if the business negotiation has failed due to any other reason such as “being currently satisfied”, “information collection”, or “silence”, that is, if the business negotiation is less likely to be successful even after the contract terms are reviewed and revised, the evaluation unit 515a determines a cold lead.

As another example, the acquired information on the business negotiation may include information indicating the lead quality of the business negotiation, namely, a hot lead or a cold lead. In this case, the evaluation unit 515a determines the lead quality of the business negotiation, namely, a hot lead or a cold lead, from the acquired information on the business negotiation.

If a hot lead is not determined as the lead quality (i.e., if a cold lead is determined as the lead quality), the evaluation unit 515a causes the process to proceed to step S1005. On the other hand, if a hot lead is determined as the lead quality, the evaluation unit 515a causes the process to proceed to step S1008.

In step S1005, the evaluation unit 515a determines whether the turn density in the evaluation-target business negotiation has a fit rate greater than or equal to 90%.

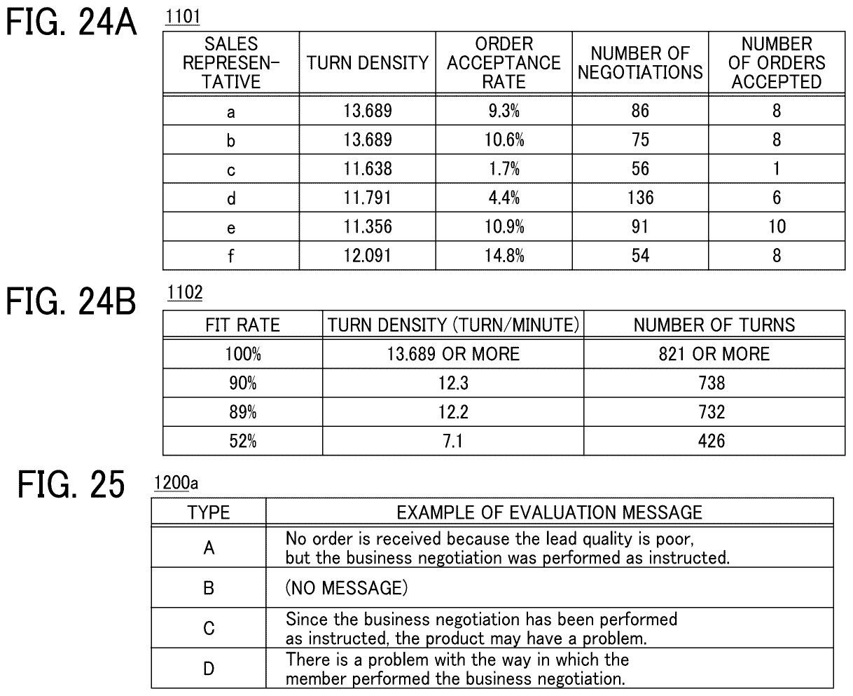

FIGS. 24A and 24B are illustrations of an example of a fit rate according to the second embodiment. In FIGS. 24A and 24B, a table 1101 illustrates a relationship between the turn density (the number of turns per minute), the order acceptance rate, the number of negotiations, and the number of orders accepted in a business negotiation in which each of sales representatives a to f has participated. The table 1101 indicates that the sales representatives a, b, and f with relatively high turn densities have higher order acceptance rates than the sales representatives c, d, and e with relatively low turn densities. This tendency is significant when the sales representatives a and b are compared with the sales representatives c and d. The sales representative e with a relatively low turn density has a relatively high order acceptance rate. According to a hearing with the sales representative e, the sales representative e has received sufficient follow-up care after business negotiations and thus has a high order acceptance rate.

Among the sales representatives except the sales representative e with a relatively high order acceptance rate due to sufficient follow-up after business negotiations, the sales representatives a, b, and f with relatively high turn densities (the numbers of turns per minute) in business negotiations have high order acceptance rates. Thus, it is indicated that the turn density in a business negotiation and the quality of the business negotiation have a correlation.

Accordingly, the evaluation unit 515a according to the present embodiment evaluates a business negotiation, based on a fit rate indicating the degree to which the turn density “13.689”, in a business negotiation, of the sales representatives a and b with relatively high turn densities and order acceptance rates and the turn density in the evaluation-target business negotiation match.

For example, as illustrated in a table 1102, the evaluation unit 515a sets a fit rate of 100% for a turn density of “13.689 or more”, which is equal to the turn density, in the business negotiation, of the sales representatives a and b with relatively high order acceptance rates, and determines a fit rate from the turn density in the evaluation-target business negotiation. In the example illustrated in the table 1102, a fit rate of “90%” is obtained when the turn density in the evaluation-target business negotiation is “12.3”, and a fit rate of “52%” is obtained when the turn density is “7.1”.

The evaluation unit 515a may calculate a fit rate from, instead of the turn density (the number of turns per minute), for example, the number of turns per hour, the number of turns during a business negotiation, or the like.

Referring back to FIG. 23, the description of the flowchart will be continued.

If it is determined in step S1005 that the fit rate is greater than or equal to 90%, the evaluation unit 515a causes the process to proceed to step S1006. On the other hand, if the fit rate is less than 90%, the evaluation unit 515a causes the process to proceed to step S1007. The fit rate “90%” is an example of a threshold, and a value different from a fit rate of “90%” may be used.

In step S1006, the evaluation unit 515a evaluates the evaluation-target business negotiation as “type A”. In the case of “type A”, the business negotiation is not successful (ends in failure) due to the low lead quality, but is considered to have no problem in view of a high fit rate. In this case, as an example, the evaluation unit 515a may output an evaluation message such as “No order is received because the lead quality is poor, but the business negotiation was performed as instructed”, based on a table 1200a as illustrated in FIG. 25.

In step S1007, the evaluation unit 515a evaluates the evaluation-target business negotiation as “type B”. In the case of “type B”, due to the poor lead quality and the insufficient fit rate, the business negotiation may have a problem. In this case, as an example, the evaluation unit 515a may output no message, based on the table 1200a as illustrated in FIG. 25.

In step S1008, the evaluation unit 515a determines whether the turn density in the evaluation-target business negotiation has a fit rate greater than or equal to 90%. If it is determined that the fit rate is greater than or equal to 90%, the evaluation unit 515a causes the process to proceed to step S1009. On the other hand, if the fit rate is less than 90%, the evaluation unit 515a causes the process to proceed to step S1010.

In step S1009, the evaluation unit 515a evaluates the evaluation-target business negotiation as “type C”. In the case of “type C”, due to the high lead quality and the high fit rate, the product may have a problem. In this case, as an example, the evaluation unit 515a may output an evaluation message such as “Since the business negotiation has been performed as instructed, the product may have a problem”, based on the table 1200a as illustrated in FIG. 25.

In step S1010, the evaluation unit 515a evaluates the evaluation-target business negotiation as “type D”. In the case of “type D”, due to the high lead quality and the low fit rate, the business negotiation may have a problem. In this case, as an example, the evaluation unit 515a may output an evaluation message such as “There is a problem with the way in which the member performed the business negotiation”, based on the table 1200a as illustrated in FIG. 25.

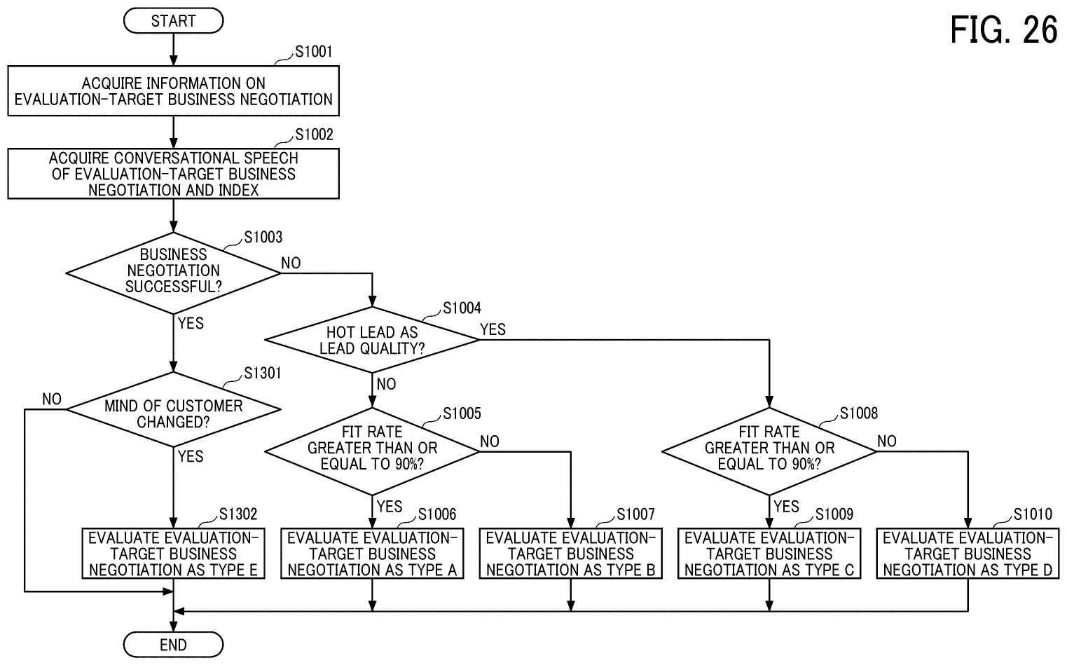

Through the process illustrated in FIG. 26, the information processing apparatus 10 can more appropriately evaluate a business negotiation even when the business negotiation is unsuccessful.

### Evaluation Process 2

FIG. 26 is a flowchart illustrating another example of the evaluation process according to the second embodiment. This process is another example of an evaluation process in which the information processing apparatus 10 evaluates an evaluation-target business negotiation to be evaluated. It is assumed that, at the point in time at which the process illustrated in FIG. 26 starts, the information processing apparatus 10 has already executed the data processing illustrated in FIG. 22.

In the process illustrated in FIG. 26, the processing of steps S1001 to S1010 is similar to the processing of steps S1001 to S1010 illustrated in FIG. 23, and the description thereof will thus be omitted.

If the evaluation-target business negotiation is successful in step S1003, the evaluation unit 515a causes the process to proceed to step S1301.

In step S1301, the evaluation unit 515a determines, in the business negotiation, whether the participant who has participated in the business negotiation has changed the mind of the customer (the other participant). If the mind of the mind of the customer has been changed, the evaluation unit 515a causes the process to proceed to step S1302. On the other hand, if the mind of the customer has not been changed, the evaluation unit 515a ends the process illustrated in FIG. 26.

In step S1302, the evaluation unit 515a evaluates the evaluation-target business negotiation as “type E”. In the case of “type E”, it is considered that the business negotiation is successful because the participant has changed the mind of the customer. In this case, as an example, the evaluation unit 515a may output an evaluation message such as “This is a good business negotiation because you succeeded in changing the customer's mind”.

As described above, the information processing apparatus 10 may evaluate a successful business negotiation, as well as a failed business negotiation.

### First Modification of Second Embodiment

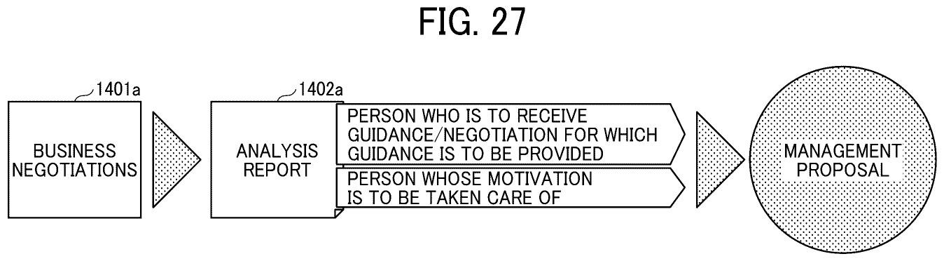

FIG. 27 is an illustration of an example of how an evaluation result is used according to a first modification of the second embodiment. The evaluation result obtained in the evaluation process according to the embodiment described with reference to FIG. 26 may be notified to, for example, a plurality of sales representatives (hereinafter referred to as members) managed by an administrator or the like or the administrator who manages the plurality of members.

As another example, as illustrated in FIG. 27, the information processing system 1 may create, based on a plurality of business negotiations 1401 a in which the members participate, an analysis report 1402a including evaluation results of the business negotiations 1401a in which the members participate, and provide a management proposal to the administrator. Accordingly, the administrator can easily determine, from the analysis report 1402a, for example, a member who is to receive guidance (or a negotiation for which guidance is to be provided) or a member whose motivation is to be taken care of, without checking all the business negotiations. The first modification describes an analysis report creation process.

### Analysis Report Creation Process

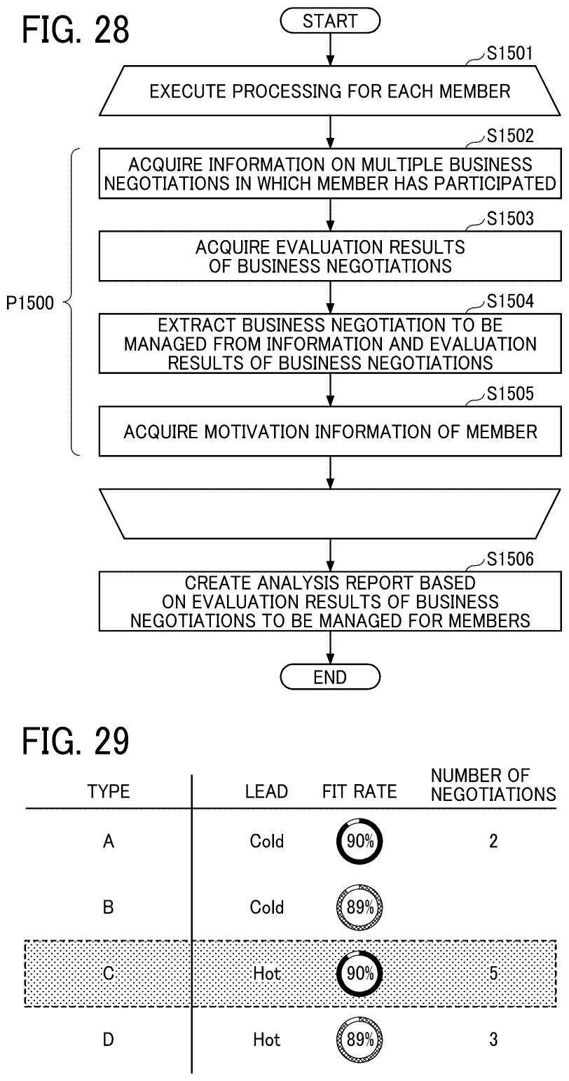

FIG. 28 is a flowchart illustrating an example of an analysis report creation process according to the first modification of the second embodiment.

In step S1501, the proposal unit 516 of the information processing apparatus 10 executes processing P1500 of steps S1502 to S1505 for each of the members managed by the administrator or the like.

In step S1502, the proposal unit 516 acquires information on a plurality of business negotiations in which the member has participated.

In step S1503, the proposal unit 516 acquires evaluation results of the business negotiations in which the member has participated. For example, the proposal unit 516 acquires the evaluation results of the business negotiations in which the member has participated, which are stored in the storage unit 519 or the like by the evaluation unit 515a. If the evaluation results of the business negotiations evaluated by the evaluation unit 515a have not been stored in the storage unit 519 or the like, the proposal unit 516 uses the evaluation unit 515a to evaluate the business negotiations in which the member has participated, and acquires the evaluation results.

In step S1504, the proposal unit 516 extracts a business negotiation to be managed from the information on the business negotiations and the evaluation results of the business negotiations.

FIG. 29 is an illustration of an example of a method for extracting a business negotiation to be managed according to the first modification of the second embodiment. As an example, as illustrated in FIG. 29, the proposal unit 516 sorts the evaluation results of the business negotiations in which the member has participated into types A to D. Further, the proposal unit 516 sets the type for which the number of business negotiations is largest (in the example illustrated in FIG. 29, type C) as the type of the member. Further, the proposal unit 516 picks up one business negotiation in the type of the member and sets the business negotiation as a “business negotiation to be managed”.

For example, the proposal unit 516 may pick up, based on the fit rate, a business negotiation with the lowest fit rate or a business negotiation with the medium fit rate. Alternatively, the proposal unit 516 may randomly pick up one business negotiation from among a plurality of business negotiations, or may pick up the latest business negotiation.

In step S1505, the proposal unit 516 acquires motivation information of the member. For example, the proposal unit 516 may acquire the motivation information of the member from a sales support service or the like provided by the external system 3. Alternatively, the proposal unit 516 may use an emotion estimation service or the like provided by the external system 3 to estimate the motivation of the member using the speech or the like uttered by the member.

When the processing P1500 of steps S1502 to S1505 is completed for the plurality of members managed by the administrator or the like, the proposal unit 516 executes the processing of step S1506.

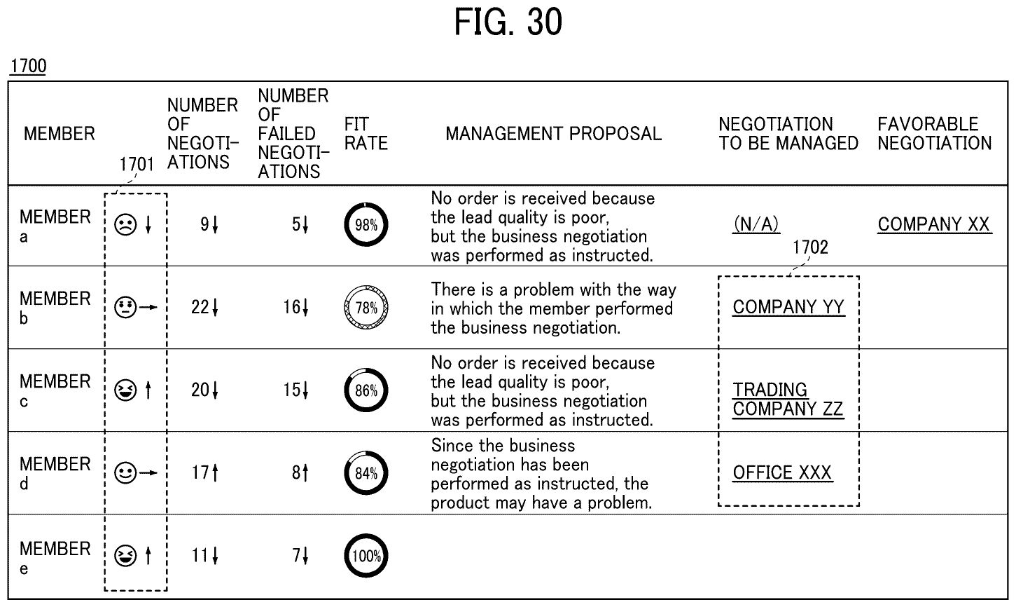

In step S1506, the proposal unit 516 creates, for example, an analysis report 1700 as illustrated in FIG. 30, based on evaluation results of business negotiations to be managed for the respective members.

FIG. 30 is an illustration of an example of an analysis report according to the first modification of the second embodiment. FIG. 30 illustrates an example of the analysis report 1700 to be displayed on the administrator terminal 101 or the like by the proposal unit 516.

In the example illustrated in FIG. 30, the analysis report 1700 includes items of information such as “member”, “number of negotiations”, “number of failed negotiations”, “fit rate”, “management proposal”, “negotiation to be managed”, and “favorable negotiation”.

The item “member” is information indicating the name or the like of each of the members managed by the administrator or the like. Preferably, a graphic symbol 1701 is displayed beside the name or the like of each member to indicate the motivation of the member and a change in the motivation of the member. The graphic symbol 1701 allows the administrator or the like to easily grasp the motivation of each member and the change in the motivation of the member.

The item “number of negotiations” is information indicating, for example, the number of business negotiations in which each member participated in a predetermined recent period of time (e.g., within one week). The item “number of failed negotiations” is information indicating the number of business negotiations for which no orders have been received among the business negotiations in which each member has participated. For example, the proposal unit 516 acquires the items of information “number of negotiations” and “number of failed negotiations” from the information on the business negotiations acquired in step S1502 illustrated in FIG. 28.

The item “management proposal” is information that proposes management for each member. In the example illustrated in FIG. 30, the proposal unit 516 sets, as a management proposal, an evaluation result of a business negotiation to be managed extracted in step S1504 illustrated in FIG. 28.

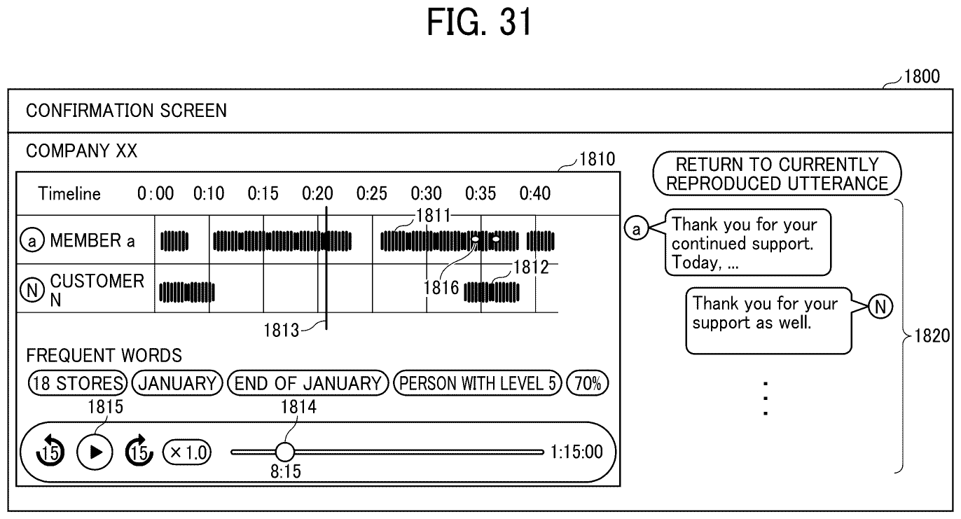

The item “negotiation to be managed” displays link information 1702 for displaying a confirmation screen for confirming the content of the business negotiation to be managed extracted in step S1504 illustrated in FIG. 28. For example, the administrator or the like selects the link information 1702 corresponding to a business negotiation to be confirmed, thereby displaying a confirmation screen 1800 as illustrated in FIG. 31 on the administrator terminal 101 or the like.

FIG. 31 is an illustration of an example of a confirmation screen according to the first modification of the second embodiment. In the example illustrated in FIG. 31, the confirmation screen 1800 displays a display screen 1810 on which an utterance state 1811 of a participant (member a) who has participated in the business negotiation and an utterance state 1812 of another participant (customer N) are displayed in time series.

The administrator or the like moves a button 1814 for setting a reproduction position to the left or right to move a bar 1813 indicating the reproduction position. Further, the administrator or the like selects a reproduction button 1815 to reproduce the speech uttered by the participant or the other participant from the position indicated by the bar 1813 indicating the reproduction position.

Preferably, in addition to (or instead of) reproducing the speech uttered by the participant or the other participant, the proposal unit 516 may display characters 1820 in, for example, a chat format from the position of the bar 1813 indicating the reproduction position. The characters 1820 are obtained by converting the speech uttered by the participant and the speech uttered by the other participant into text.

Preferably, the proposal unit 516 may display a marker 1816 at a point in time when the speech volume representing the utterance state 1811 of the participant or the utterance state 1812 of the other participant is high, at a point in time when the turn density is high, or at a point in time when the speech rate is high, for example. Alternatively, the proposal unit 516 may display the marker 1816 at a portion or the like that becomes a problem during the business negotiation.

The confirmation screen 1800 illustrated in FIG. 31 allows the administrator or the like to easily confirm the content of the business negotiation to be managed.

### Conversational Speech Reproduction Process

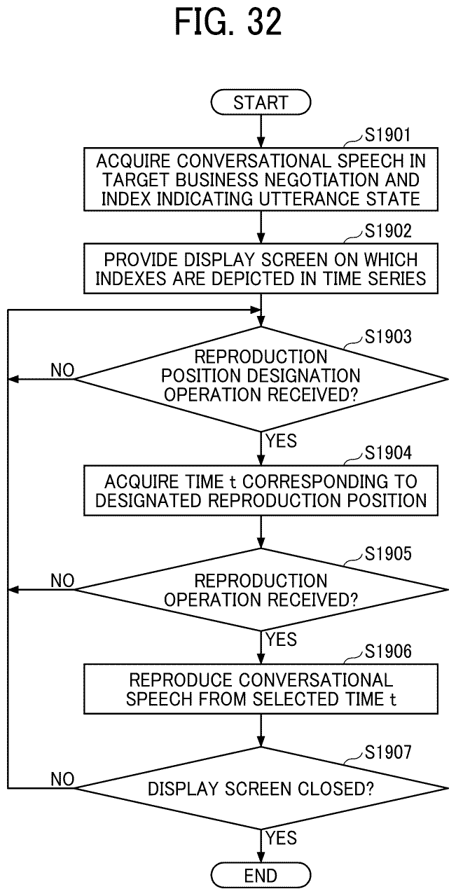

FIG. 32 is a flowchart illustrating an example of a conversational speech reproduction process according to the first modification of the second embodiment. This process is an example of a process executed by the information processing apparatus 10 in response to, for example, selection of the link information 1702 in the analysis report 1700 illustrated in FIG. 30.

In step S1901, the provision unit 517 acquires a conversational speech in a target business negotiation and an index indicating an utterance state. For example, the provision unit 517 acquires, from the storage unit 519 or the like, the conversational speech and the index stored by the evaluation unit 515a in step S907 in FIG. 22.

In step S1902, the provision unit 517 provides a display screen on which indexes indicating utterance states in the business negotiation are depicted in time series. For example, as illustrated in FIG. 31, the provision unit 517 causes the administrator terminal 101 or the like to display the display screen 1810 on which the utterance state 1811 of the participant who has participated in the business negotiation and the utterance state 1812 of the other participant who has participated in the business negotiation are displayed in time series.

In step S1903, the output unit 518 determines whether an operation of designating a reproduction position has been received. For example, when the administrator or the like moves the button 1814 for setting a reproduction position on the confirmation screen 1800 as illustrated in FIG. 31, the output unit 518 determines that the operation of designating a reproduction position has been received. If the operation of designating a reproduction position has been received, the output unit 518 causes the process to proceed to step S1904. On the other hand, if the operation of designating a reproduction position has not been received, the output unit 518 executes the processing of step S1903 again.

In step S1904, the output unit 518 acquires a time t corresponding to the designated reproduction position. For example, when the administrator or the like moves the button 1814 for setting a reproduction position on the confirmation screen 1800 as illustrated in FIG. 31, the provision unit 517 moves the bar 1813 indicating a reproduction position to the set position. Further, the output unit 518 acquires the time t corresponding to the position of the bar 1813 indicating a reproduction position.

In step S1905, the output unit 518 determines whether an operation of reproducing a conversational speech has been received. For example, when the administrator or the like selects the reproduction button 1815 on the confirmation screen 1800 as illustrated in FIG. 31, the output unit 518 determines that the reproduction operation has been received. If the reproduction operation has been received, the output unit 518 causes the process to proceed to step S1906. On the other hand, if the reproduction operation has not been received, for example, the output unit 518 returns the process to step S1903.

In step S1906, the output unit 518 reproduces a conversational speech (a speech uttered by the participant or a speech uttered by the other participant) from the acquired time t. For example, the output unit 518 transmits audio data of a conversational speech after the time t to the administrator terminal 101 to cause the administrator terminal 101 to output the conversational speech after the time t.

In step S1907, the information processing apparatus 10 determines whether the administrator or the like has closed the display screen. If the display screen is not closed, the information processing apparatus 10 returns the process to step S1903. On the other hand, if the display screen is closed, the information processing apparatus 10 ends the process illustrated in FIG. 32.

Through the process illustrated in FIG. 32, the information processing system 1 can display the confirmation screen 1800 as illustrated in FIG. 31 and reproduce the speech uttered by the participant or the other participant who has participated in the business negotiation from a position designated by the administrator or the like.

The conversational speech reproduction process illustrated in FIG. 32 is an example. For example, the output unit 518 may execute the processing of steps S1903 and S1904 in parallel with the processing of steps S1905 and S1906.

### Second Modification of Second Embodiment

In the example illustrated in FIG. 30, the proposal unit 516a displays the evaluation results of the business negotiations obtained by the evaluation unit 515a in the item “management proposal” of the analysis report 1700.

This is an example. For example, the proposal unit 516 may propose management for each member, based on the evaluation result of a business negotiation obtained by the evaluation unit 515a and the motivation of the member.

### Analysis Report Creation Process

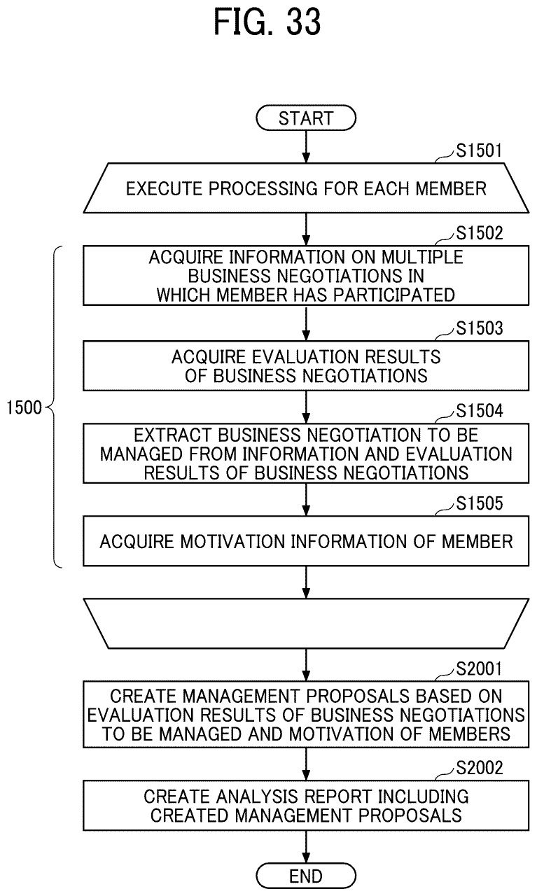

FIG. 33 is a flowchart illustrating an example of an analysis report creation process according to a second modification of the second embodiment. In the process illustrated in FIG. 33, the processing of steps S1501 to S1505 is similar to the processing of steps S1501 to S1505 illustrated in FIG. 28, and the description thereof will thus be omitted.

When the processing P1500 of steps S1502 to S1505 is completed for the plurality of members managed by the administrator, the proposal unit 516 executes the processing of steps S2001 and S2002.

In step S2001, the proposal unit 516 creates management proposals, based on the evaluation results of the business negotiations to be managed and the motivation of the members.

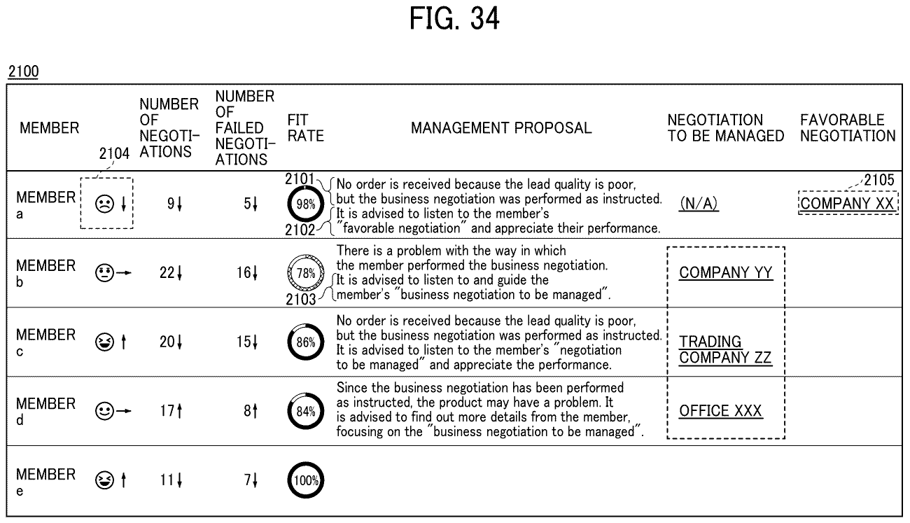

In step S2002, the proposal unit 516 creates an analysis report including the created management proposals. For example, the proposal unit 516 creates an analysis report 2100 as illustrated in FIG. 34.

FIG. 34 is an illustration of an example of an analysis report according to the second modification of the second embodiment. As in the analysis report 1700 described with reference to FIG. 30, the analysis report 2100 illustrated in FIG. 34 includes items of information such as “member”, “number of negotiations”, “number of failed negotiations”, “fit rate”, “management proposal”, “negotiation to be managed”, and “favorable negotiation”. The items of information other than the item “management proposal” may be similar to those in the analysis report 1700 described with reference to FIG. 30.

The item “management proposal” displays a management proposal 2102, in addition to an evaluation result 2101 of a business negotiation to be managed extracted in step S1504 illustrated in FIG. 33. The management proposal 2102 takes into account a motivation 2104 of the member.

For example, in FIG. 34, due to the high fit rate, the member a is considered to have performed a good business negotiation. However, due to the poor lead quality (many cold leads), the business negotiation ends in failure, and the motivation of the member a may decrease.

In this case, no guidance is to be provided to the member a for the business negotiation, but the administrator or the like desirably provides care so that the motivation of the member a does not decrease. Accordingly, for example, the proposal unit 516 displays the message “It is advised to listen to the member's favorable negotiation and appreciate their performance” as the management proposal 2102 that takes into account the motivation 2104 of the member a.

In this case, it is desirable that the proposal unit 516 display, in the analysis report 2100, link information 2105 for displaying a confirmation screen of the “favorable negotiation”, instead of the “negotiation to be managed”.

In FIG. 34, in contrast, due to the low fit rate, the member b is considered to have a problem with the way in which the member b performs business negotiations. However, the motivation of the member b is kept constant, and it is desirable that the administrator or the like promptly gives guidance on how to perform business negotiations. Accordingly, for example, the proposal unit 516 displays the message “It is advised to listen to and guide the member's business negotiation to be managed” as a management proposal 2103 that takes into account the motivation of the member b.

For example, the proposal unit 516 may use a machine learning model or the like trained by machine learning in advance to make a management proposal in consideration of the motivation of each member so as to output the management proposal, based on the evaluation result of the business negotiation obtained by the evaluation unit 515a and the motivation of the member.

Machine learning is a technology for making a computer acquire human-like learning ability. Machine learning refers to a technology in which a computer autonomously generates an algorithm to be used for determination such as data identification from training data captured in advance and applies the generated algorithm to new data to make a prediction. The learning method for machine learning is not limited to supervised learning and may be, for example, unsupervised learning, semi-supervised learning, reinforcement learning, deep learning, or the like.

According to the second modification, the information processing system 1 proposes management for a member, based on the evaluation result of a business negotiation obtained by the evaluation unit 515a and the motivation of the member, and can thus make a more appropriate management proposal.

As described above, according to the second embodiment, an information processing system for evaluating communication such as a business negotiation can evaluate the communication in consideration of the content of the communication.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The group of apparatuses described in one or more embodiments is merely representative of one of multiple computing environments for implementing the embodiments disclosed herein. In one embodiment, for example, the information processing apparatus 10, which may be referred to as the communication support apparatus 10, and the external system 3 include multiple computing devices such as a server cluster. The multiple computing devices are configured to communicate with one another through any type of communication link including, for example, a network and a shared memory, and perform the processes disclosed herein.

In the first embodiment, the communication support apparatus 10, the terminal apparatus 100, and the information terminal 101 can be configured to share the disclosed processing steps, for example, the processes illustrated in FIGS. 7, 8, 11, and 13, in various combinations. For example, a process executed by the communication support apparatus 10 may be executed by the terminal apparatus 100 or the information terminal 101. Further, a process executed by the terminal apparatus 100 and a process executed by the information terminal 101 may be executed by the communication support apparatus 10. The components of the communication support apparatus 10 may be integrated into one apparatus or divided into a plurality of apparatuses.

In the second embodiment, the information processing apparatus 10, the terminal apparatus 100, and the administrator terminal 101 can be configured to share the disclosed processing steps, for example, the processes illustrated in FIGS. 22, 23, 26, 28, 32, and 33, in various combinations. For example, a process executed by the information processing apparatus 10 may be executed by the terminal apparatus 100 or the administrator terminal 101. Further, a process executed by the terminal apparatus 100 and a process executed by the administrator terminal 101 may be executed by the information processing apparatus 10. The components of the information processing apparatus 10 may be integrated into one apparatus or divided into a plurality of apparatuses.

A communication support system, a communication support apparatus, a communication support method, and a program according to the first embodiment are disclosed herein.

In a first aspect, a communication support system includes an acquisition unit, a determination unit, and an information providing unit. The acquisition unit acquires a speech uttered by one or more participants participating in the communication. In accordance with an utterance made by the one or more participants, the determination unit determines whether the communication is to be supported, from the speech uttered by the one or more participants. The information providing unit provides information supporting the communication in a case where it is determined that the communication is to be supported.

According to a second aspect, in the communication support system of the first aspect, the determination unit detects one or more predetermined keywords from the speech uttered by the one or more participants, and in response to the one or more predetermined keywords being detected, the information providing unit provides information supporting the communication corresponding to the detected one or more predetermined keywords.

According to a third aspect, in the communication support system of the second aspect, the one or more participants include a first participant participating in the communication, and a second participant different from the first participant, the acquisition unit acquires a speech uttered by the second participant from a terminal apparatus used by the first participant, and the determination unit detects the one or more predetermined keywords from the speech uttered by the second participant.

According to a fourth aspect, in the communication support system of the third aspect, the information providing unit causes the terminal apparatus used by the first participant to display information supporting the communication.

According to a fifth aspect, in the communication support system of the third aspect or the fourth aspect, the information providing unit provides information supporting the communication in real time in accordance with an utterance made by the second participant.

According to a sixth aspect, in the communication support system of any one of the third aspect to the fifth aspect. The acquisition unit acquires the speech uttered by the second participant from the terminal apparatus from which the speech uttered by the one or more participants including the speech uttered by the second participant is transmitted.

According to a seventh aspect, in the communication support system of any one of the third aspect to the sixth aspect, the determination unit detects the one or more predetermined keywords, the one or more predetermined keywords being registered in a support database in which information supporting the communication is registered, and the first participant selects the support database in which the one or more predetermined keywords to be detected are registered.

According to an eighth aspect, in the communication support system of the seventh aspect, the support database includes a plurality of questions and answers to the plurality of questions, and the information providing unit causes the terminal apparatus used by the first participant to display a question corresponding to the one or more predetermined keywords detected by the determination unit among the plurality of questions, and an answer to the question.

According to a ninth aspect, in the communication support system of the seventh aspect or the eighth aspect, the support database includes one or more databases among a database related to a frequently asked question (FAQ), a database related to an anticipated question and an answer, a database related to product information, a database related to industry information, and a database related to conversation information.

According to a tenth aspect, in the communication support system of the second aspect, the information providing unit does not provide information supporting the communication in a case where the one or more predetermined keywords are not detected.

In an eleventh aspect, a communication support apparatus includes an acquisition unit, a determination unit, and an information providing unit. The acquisition unit acquires a speech uttered by one or more participants participating in the communication. In accordance with an utterance made by the one or more participants, the determination unit determines whether the communication is to be supported, from the speech uttered by the one or more participants. The information providing unit provides information supporting the communication in a case where it is determined that the communication is to be supported.

In a twelfth aspect, a communication support method includes, by a computer, acquiring a speech uttered by one or more participants participating in the communication; determining, in accordance with an utterance made by the one or more participants, whether the communication is to be supported, from the speech uttered by the one or more participants; and providing information supporting the communication in a case where it is determined that the communication is to be supported.

In a thirteenth aspect, a program causes a computer to execute acquiring a speech uttered by one or more participants participating in the communication; determining, in accordance with an utterance made by the one or more participants, whether the communication is to be supported, from the speech uttered by the one or more participants; and providing information supporting the communication in a case where it is determined that the communication is to be supported.

An information processing system, an information processing apparatus, an information processing method, and a program according to the second embodiment are disclosed herein.

In a first aspect, an information processing system includes an acquisition unit, a calculation unit, and an evaluation unit. The acquisition unit acquires a speech uttered by a participant participating in communication and a speech uttered by another participant participating in the communication. The calculation unit calculates an index indicating an utterance state in the communication, based on the speech uttered by the participant and the speech uttered by the other participant. The evaluation unit evaluates the communication, based on a result of the communication and a comparison result between the calculated index and a reference index.

According to a second aspect, in the information processing system of the first aspect, the calculation unit calculates the index, based on the number of turns of speeches uttered in the communication.

According to a third aspect, in the information processing system of the first aspect or the second aspect, the index includes a turn density that is the number of turns per unit time.

According to a fourth aspect, in the information processing system of any one of the first aspect to the third aspect, the communication is a business negotiation in which the participant and the other participant participate, and in a case where the business negotiation is not successful, the evaluation unit evaluates the business negotiation, based on the comparison result between the calculated index and the reference index.

According to a fifth aspect, in the information processing system of the fourth aspect, the evaluation unit evaluates the business negotiation, based further on a reason for the business negotiation being unsuccessful.

According to a sixth aspect, in the information processing system of the fourth aspect, the evaluation unit evaluates the business negotiation, based further on a lead quality of the business negotiation indicating a hot lead or a cold lead.

According to a seventh aspect, in the information processing system of any one of the fourth aspect to the sixth aspect, the evaluation unit outputs an evaluation result including information indicating whether there is a problem in how to perform the business negotiation.

According to an eighth aspect, the information processing system of any one of the fourth aspect to the sixth aspect further includes a proposal unit. The proposal unit proposes management for the participant, based on an evaluation result obtained by the evaluation unit evaluating a plurality of business negotiations in which the participant has participated.

According to a ninth aspect, in the information processing system of the eighth aspect, the proposal unit proposes management for the participant, based further on a motivation of the participant.

According to a tenth aspect, in the information processing system of the eighth aspect or the ninth aspect, the proposal unit extracts a business negotiation to be managed among the plurality of business negotiations, based on the evaluation result of the plurality of business negotiations, and proposes management for the participant, based on the business negotiation to be managed.

According to an eleventh aspect, the information processing system of the tenth aspect further includes a provision unit and an output unit. The provision unit provides a display screen to display an utterance state of the participant and an utterance state of the other participant in time series, based on a speech uttered by the participant and a speech uttered by the other participant in the business negotiation to be managed. The output unit outputs content of an utterance of a selected portion from the utterance state of the participant and the utterance state of the other participant displayed on the display screen.

In a twelfth aspect, an information processing apparatus includes an acquisition unit, a calculation unit, and an evaluation unit. The acquisition unit acquires a speech uttered by a participant participating in communication and a speech uttered by another participant participating in the communication. The calculation unit calculates an index indicating an utterance state in the communication, based on the speech uttered by the participant and the speech uttered by the other participant. The evaluation unit evaluates the communication, based on a result of the communication and a comparison result between the calculated index and a reference index.

In a thirteenth aspect, an information processing method includes, by a computer, acquiring a speech uttered by a participant participating in communication and a speech uttered by another participant participating in the communication; calculating an index indicating an utterance state in the communication, based on the speech uttered by the participant and the speech uttered by the other participant; and evaluating the communication, based on a result of the communication and a comparison result between the calculated index and a reference index.

In a fourteenth aspect, a program causes a computer to execute a process, or a storage medium stores the program. The process includes acquiring a speech uttered by a participant participating in communication and a speech uttered by another participant participating in the communication; calculating an index indicating an utterance state in the communication, based on the speech uttered by the participant and the speech uttered by the other participant; and evaluating the communication, based on a result of the communication and a comparison result between the calculated index and a reference index.

1. A system for supporting communication, the system comprising circuitry configured to:
acquire a speech uttered by one or more participants participating in the communication;
determine, in accordance with an utterance made by the one or more participants, whether the communication is to be supported, from the speech uttered by the one or more participants; and
provide information supporting the communication based on a determination that the communication is to be supported.

2. The system according to claim 1, wherein
the circuitry is configured to:
detect one or more predetermined keywords from the speech uttered by the one or more participants; and
provide, in response to detection of the one or more predetermined keywords, the information supporting the communication corresponding to the detected one or more predetermined keywords.

3. The system according to claim 2, wherein
the one or more participants include a first participant participating in the communication, and a second participant different from the first participant, and
the circuitry is configured to:
acquire a speech uttered by the second participant from a terminal apparatus used by the first participant; and
detect the one or more predetermined keywords from the speech uttered by the second participant.

4. The system according to claim 3, wherein
the circuitry is configured to cause the terminal apparatus used by the first participant to display the information supporting the communication.

5. The system according to claim 3, wherein
the circuitry is configured to provide the information supporting the communication in real time in accordance with an utterance made by the second participant.

6. The system according to claim 3, wherein
the circuitry is configured to acquire the speech uttered by the second participant from the terminal apparatus from which the speech uttered by the one or more participants including the speech uttered by the second participant is transmitted.

7. The system according to claim 3, wherein
the circuitry is configured to detect the one or more predetermined keywords, the one or more predetermined keywords being registered in a support database in which information supporting the communication is registered, and
the first participant selects the support database in which the one or more predetermined keywords to be detected are registered.

8. The system according to claim 7, wherein
the support database includes a plurality of questions and answers to the plurality of questions, and
the circuitry is configured to cause the terminal apparatus used by the first participant to display a question corresponding to the detected one or more predetermined keywords among the plurality of questions, and an answer to the question.

9. The system according to claim 7, wherein
the support database includes one or more databases among a database related to a frequently asked question (FAQ), a database related to an anticipated question and an answer, a database related to product information, a database related to industry information, and a database related to conversation information.

10. The system according to claim 2, wherein
the circuitry is configured to determine that the communication is not to be supported in a case where the one or more predetermined keywords are not detected, such that the information supporting the communication is not provided.

11. An apparatus for supporting communication, the apparatus comprising circuitry configured to:
acquire a speech uttered by one or more participants participating in the communication;
determine, in accordance with an utterance made by the one or more participants, whether the communication is to be supported, from the speech uttered by the one or more participants; and
provide information supporting the communication based on a determination that the communication is to be supported.

12. A method for supporting communication, the method comprising:
acquiring a speech uttered by one or more participants participating in the communication;
determining, in accordance with an utterance made by the one or more participants, whether the communication is to be supported, from the speech uttered by the one or more participants; and
providing information supporting the communication based on a determination that the communication is to be supported.
